(19) United States
(12) Patent Application Publication
(10) Pub. No.: US 2021/0365775 A1
(43) Pub. Date: Nov. 25, 2021

(54) DATA IDENTIFICATION USING NEURAL NETWORKS

(71) Applicant: ACCENTURE GLOBAL SOLUTIONS LIMITED, Dublin 4 (IE)

(72) Inventors: Anitha S NAYAR, Bangalore (IN); Revathi RAMESH, Bangalore (IN); Souvik SAHA, Durgapur (IN)

(73) Assignee: ACCENTURE GLOBAL SOLUTIONS LIMITED, Dublin 4 (IE)

(21) Appl. No.: 16/922,793

(22) Filed: Jul. 7, 2020

(30) Foreign Application Priority Data
May 22, 2020 (IN) 202011021634

(51) Int. Cl. G06N 3/08; G06N 3/04

(52) U.S. Cl. CPC G06N 3/08; G06N 3/0445; G06N 3/0454

(57) ABSTRACT

Examples of determining a classification for an input dataset are provided. The input dataset may be defined in a one-dimensional data structure. The input data set may be converted into a formatted dataset of a two-dimensional data structure, a format of the formatted dataset being defined in accordance to a type of a deep neural network component. The formatted dataset may be processed through multiple layers of the deep neural network component. Based on the processing of the formatted dataset, a classification indicative of a probability of a data feature of the input dataset corresponding to an identity parameter, which may include sensitive data, associated with an identity of the individual, may be determined. A user may be provided the data feature of the input dataset corresponding to the identity parameter in a first format and another data features of the input dataset in a second format different than the first format.

### BACKGROUND

In today's digital world, data is a valued resource. Many industries work towards maintaining the privacy, integrity, and authenticity of the data. With the growth of industries, the data handled by these industries has also grown exponentially and protecting the data such as, for example, personal data, has become critical. Also, with stricter regulations on data privacy and huge fines associated with non-compliance with data privacy policies, many organizations are focused on developing mechanisms and procedures to protect sensitive data. Protecting sensitive data requires identifying personal identifiable information for a wide range of attributes in a dataset and tagging the information accurately.

However, identification of the sensitive data from amongst a pool of data in a database has associated challenges. For instance, some existing techniques to identify sensitive data from data sources (e.g. structured databases and unstructured data sources) rely on the use of regular expressions-based matching and/or a look up against a reference master list of values. These techniques use predefined rules to identify patterns in data and accordingly tag the data to be sensitive or insensitive. However, in many situations, there may not exist a known pattern that may be modeled as a regular expression in the data. Also, in some cases, there may exist a similar pattern in the data corresponding to two categories and using such a pattern may result in inaccurate identification of the sensitive data. Therefore, these techniques may not provide effective results.

Accordingly, an identification of sensitive data from a dataset in an efficient and accurate manner is challenging and has associated limitations. Furthermore, a technical problem with the currently available solutions for identifying and tagging sensitive data in a dataset is identifying un-recognized patterns and/or other associated characteristics in different data attributes of a dataset, which may otherwise remain un-identifiable when some existing predefined rules are used.

### BRIEF DESCRIPTION OF DRAWINGS

FIG. 1 illustrates a system for personal data identification, according to an example embodiment of the present disclosure.

FIG. 2 illustrates various components of the system for personal data identification, according to an example embodiment of the present disclosure.

FIG. 3 schematically illustrates identification of sensitive data in a dataset, according to an example embodiment of the present disclosure.

FIG. 4 illustrates a pictorial representation of a sample input dataset, according to an example embodiment of present disclosure.

FIG. 5 illustrates a pictorial representation of metadata associated with the sample input dataset, according to an example embodiment of present disclosure.

FIG. 6 illustrates a pictorial representation of a classification of the input dataset using a convolutional neural network modeler, according to an example embodiment of present disclosure.

FIG. 7A illustrates a pictorial representation of data manipulation by a data manipulator using a first data encoder, according to an example embodiment of the present disclosure.

FIG. 7B illustrates a pictorial representation of a formatted dataset by the data manipulator, according to an example embodiment of the present disclosure.

FIG. 8 illustrates a pictorial representation of data manipulation of the input dataset by a data manipulator using a second data encoder, according to an example embodiment of the present disclosure.

FIG. 9 illustrates a pictorial representation of a classification of the input dataset using a recurrent neural network modeler, according to an example embodiment of present disclosure.

FIG. 10 illustrates loss and accuracy plots for classification performed based on a set of epochs using a convolutional neural network modeler, in accordance with an example implementation of the present disclosure.

FIG. 11 illustrates loss and accuracy graphs for classification performed on training and validation datasets, using a convolutional neural network modeler, in accordance with another example implementation of the present disclosure.

FIG. 12 illustrates loss and accuracy graphs for classification performed based on a set of epochs, using recurrent neural network modeler, in accordance with an example implementation of the present disclosure.

FIG. 13 illustrates loss and accuracy graphs for classification performed on training and validation datasets using recurrent neural network modeler, in accordance with another example implementation of the present disclosure.

FIG. 14 illustrates a process flow of the model training for classification of an input dataset, according to an example embodiment of present disclosure.

FIG. 15 illustrates a process flow for classification of a structured dataset, according to an example embodiment of present disclosure.

FIG. 16 illustrates a process flow for of classification of an unstructured dataset by an identification classifier, according to an example embodiment of present disclosure.

FIG. 17 illustrates a hardware platform for the implementation of a system for personal data identification, according to an example embodiment of the present disclosure.

FIGS. 18A-18D illustrate process flowcharts for determining classification for an input dataset, according to an example embodiment of the present disclosure.

### DETAILED DESCRIPTION

For simplicity and illustrative purposes, the present disclosure is described by referring mainly to examples thereof. The examples of the present disclosure described herein may be used together in different combinations. In the following description, details are set forth in order to provide an understanding of the present disclosure. It will be readily apparent, however, that the present disclosure may be practiced without limitation to all these details. Also, throughout the present disclosure, the terms “a” and “an” are intended to denote at least one of a particular element. The terms “a” and “an” may also denote more than one of a particular element. As used herein, the term “includes” means includes but not limited to, the term “including” means including but not limited to. The term “based on” means based at least in part on, the term “based upon” means based at least in part upon, and the term “such as” means such as but not limited to. The term “relevant” means closely connected or appropriate to what is being done or considered.

The present disclosure describes identifying and tagging Personally Identifiable Information (PII). In an example, a Personally Identifiable Information Tagging System (PIITS) may be implemented. The PIITS (hereinafter referred to as “system”) may include application of deep neural network models, such as Convolutional Neural Network (CNN) and Recurrent Neural Network (RNN) to identify the PII in a numeric attribute and/or an alphanumeric attribute. The PII may include, for example, a government issued unique identification numbers, such as Social Security Number (SSN), postal codes, National Provider Identifier (NPI), and any custom numeric or alphanumeric identification. The system may include a processing model for feature engineering to convert input data to a format suited for a selected neural network, such as a CNN model and an RNN model, from a numeric or an alphanumeric attribute. In an example, the system may include a tailored and enhanced RNN model using concepts such as Adaptive Average Pooling (AAP) and Adaptive Max Pooling (AMP) to create a concatenated pooling layer to improve the identification accuracy of PII.

In an example embodiment, the system may include a processor, a data manipulator, an identification classifier, and a neural network component selector. The processor may be coupled to the data manipulator, the identification classifier, and the neural network component selector. The data manipulator may obtain an input dataset defined in a one-dimensional data structure. The data manipulator may convert the input dataset into a formatted dataset of a two-dimensional data structure, wherein a format of the formatted dataset may be defined in accordance with a type of a deep neural network component, such as a CNN component or an RNN component. The neural network component selector may identify the characteristic associated with the input dataset based on a pre-defined parameter, where the pre-defined parameter comprises at least a size of the input dataset and/or a length of individual elements in the dataset. In an example, when a size is greater than a predetermined size, the CNN component may be selected, otherwise the RNN component.

Referring back to the formatted dataset, the identification classifier may process the formatted dataset by the deep neural network component. The formatted dataset may be processed to determine a classification indicative of a probability of the input dataset to correspond to an identity parameter, which may be indicative of sensitive data, such as personal information associated with an individual so that a user may be provided information corresponding to the input dataset in an appropriate format. In an example, a data feature of the input dataset may be provided in a format different from a format corresponding to another feature of the input dataset.

Thus, the system provides a unique way to tag sensitive data. The system may facilitate application of deep neural networks on a single numeric and alphanumeric attribute. The system may present a feature engineering model to process an input dataset into a format suitable for CNN/RNN model. The system may facilitate enhanced and customized bi-directional scanning to infer patterns using the RNN model. In accordance with various embodiments of the present disclosure, the system may differentiate between various types of PII. For example, the system may differentiate the SSN stored in a nine (9)-digit format from all other nine (9)-digit numeric attributes, such as United States (US) Bank Routing Number. The system may differentiate US zip codes stored as a five (5)-digit number from the other five (5)-digit number attributes such as salary. The system may differentiate National Provider Identifier (NPI) that may be a unique ten (10)-digit identification number issued to health care providers in the United States from other 10-digit number attributes like mobile numbers. The system may differentiate any custom numeric or alphanumeric document identifier that may be used by an organization to uniquely identify individuals, from other similarly-formatted attributes. Thus, the system may deduce a mechanism of modifying a data identification technique, in near real-time, based on the identification of unrecognized patterns and the associated characteristics in the dataset.

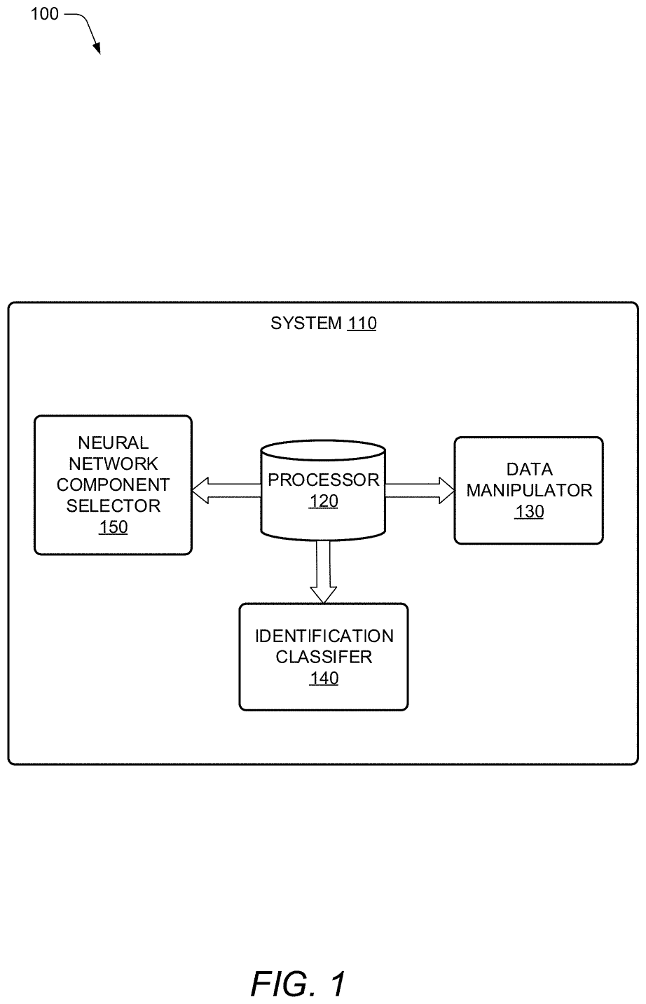

FIG. 1 illustrates a system 100 for identifying sensitive data from an input dataset, according to an example implementation of the present disclosure. The input dataset may include data associated with an individual. The system 100 may output a classification indicating a probability that a data feature of the input dataset may be a personal identifier. Further, the personal identifier may be associated with the identity of the individual. The system 100 may further provide a first notification for the data feature of the input dataset identified as the personal identifier. The system 100 may provide this notification in a first format. Further, the system 100 may provide a second notification for the data features of the input dataset that may not correspond to the personal identifier in a second format, different than a first format. Accordingly, the system 100 may determine that the input dataset includes the personal identifier and may also flag it differently than the remaining data of the input dataset. The system 100 may include a processor 120. The processor 120 may be coupled to a data manipulator 130, a neural network component selector 150, and an identification classifier 140.

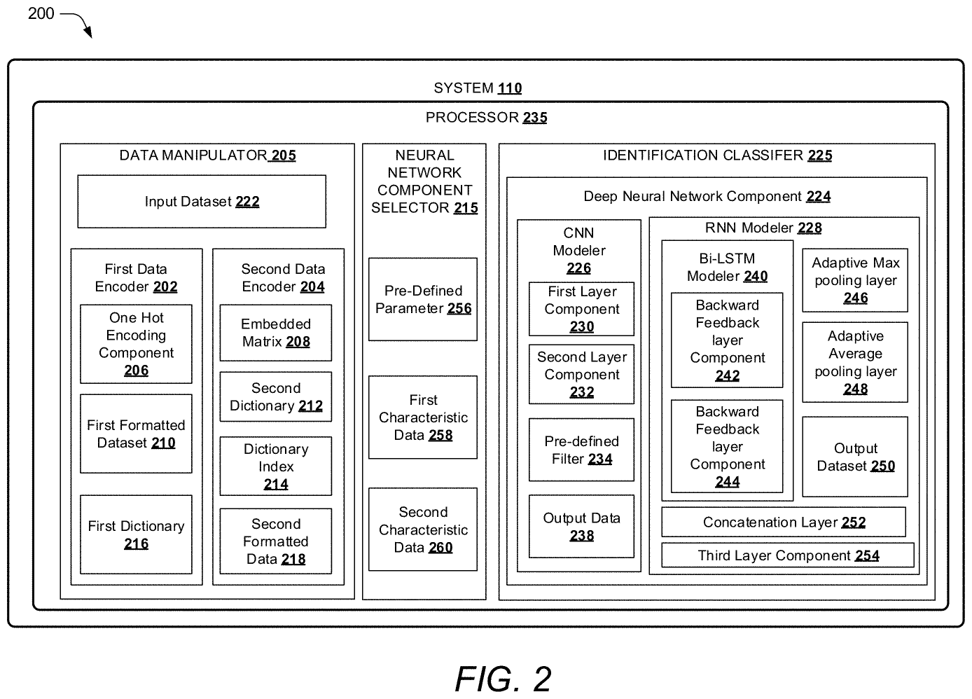

The data manipulator 130 may correspond to a component that may manipulate data from a first format to a second format. For instance, according to an example, the data manipulator 130 may obtain an input dataset that may be defined in a one-dimensional data structure and convert it into the formatted dataset that may be defined in a two-dimensional data structure. In some examples, the data manipulator 130 may convert the input dataset to the formatted dataset which may be defined in a format according to a type of a deep neural network component, details of which are described further in reference to FIGS. 2-18D.

The neural network component selector 150 may correspond to a component that may select a neural network component. The neural network component selector 150 may select the neural network component based on a characteristic associated with the input dataset. The characteristic associated with the input dataset may be based on a predefined parameter, for example, a total size of the input dataset and/or the length of the individual elements that may be included within the input dataset. In an example, the neural network component selector 150 may select the neural network component to be a convolutional neural network component when the input dataset is of a first characteristic. The first characteristic may be indicative of a size being greater than a predetermined size, for example, a dataset having a length more than five characters. In another example, the neural network component selector 150 may select the neural network component to be a recurrent neural network component when the input dataset is of a second characteristic. The second characteristic may be indicative of a size being less than the predetermined size, for example, a dataset having a length less than five characters. Accordingly, the neural network component selector 150 may select the neural network component which may be further used for processing the input dataset to determine if the input dataset includes the sensitive data, e.g. a personal identifier associated with an individual.

The identification classifier 140 may correspond to a component that may identify and output a classification associated to the input dataset. The classification may indicate a probability that a data feature of the input dataset corresponds to a personal identifier. Said differently, the identification classifier may identify whether any data feature of the input dataset is related to sensitive data, for example, the personal identifier. As stated earlier, the personal identifier may be associated with an identity of the person. In other words, in some examples, the personal identifier may uniquely identify an individual/person. For instance, in an example, the personal identifier may be a social security number (SSN). Further details of the identification of the sensitive data from the input dataset are described in reference to FIGS. 2-18D.

FIG. 2 illustrates various components of a system 200 for the identification of the sensitive data from the input dataset. The system 200 may include one or more components that may perform one or more operations for identifying sensitive data (e.g. personal identification data) from a dataset. The system 200 may be an exemplary embodiment of the system 110 described above and all components of the system 200 may be used for deploying the system 110. As illustrated, the system 200 may include a processor 235, similar in functionality to the processor 120. The processor 235 may be coupled to a data manipulator 205, a neural network component selector 215, and an identification classifier 225. The data manipulator 205, the neural network component selector 215, and the identification classifier 225 may be similar in functionality to the data manipulator 130, the neural network component selector 150, and the identification classifier 140, respectively. Various components of the system 200 may perform their respective operations for identifying the sensitive data from a dataset.

According to an example embodiment, the data manipulator 130 may obtain an input dataset 222 and manipulate the input dataset 222 into a formatted dataset. The input dataset 222 may be defined in a one-dimensional data structure and may include data that may be associated with a person. The data manipulator 205 may manipulate the input dataset 222 to the formatted dataset by encoding each character of the input dataset 222 using a predefined dictionary and a predefined encoding function. In some examples, the data manipulator 205 may convert the input dataset 222 defined in the one-dimensional structure to the formatted dataset that may be a dataset defined in a two-dimensional data structure.

Illustratively, the system 200 may include the neural network component selector 215 that may be used for the selection of a neural network component. The neural network component may be a component that may be used for processing the formatted dataset through a deep neural network (e.g. a convolutional neural network or a recurrent neural network). In an example, the neural network component selector 215 may select the neural network component based on identifying a characteristic associated with the input dataset 222 (e.g. a size of the input dataset 222). Furthermore, the identification classifier 225 may process the formatted dataset based on the neural network component selected by the neural network component selector 215.

In some examples, the neural network component may correspond to a deep neural network component that may include a plurality of neural network layers (e.g. initial layers, convolutional layers, embedding layers, pooling layers, etc.) of a deep neural network that may be used for processing the formatted dataset. Furthermore, based on the processing of the formatted dataset, the identification classifier 225 may identify a classification that may indicate a probability that a data feature of the input dataset 222 corresponds to a personal identifier associated with a person. In other words, the classification may indicate a probability that the input dataset 222 may include sensitive data.

For processing data using deep neural networks, the input dataset 222 may be converted to the formatted dataset. The formatted dataset may include data defined in a format supported by the deep neural network. Accordingly, before using the deep neural network, the system 200 may convert the input dataset 222 to the formatted dataset, as stated earlier. Illustratively, the system 200 includes the data manipulator 205 for converting the input dataset 222 into the formatted dataset. The data manipulator 205 may include a first data encoder 202 and a second data encoder 204. The first data encoder 202 may correspond to a component that may be used for manipulating the data when the input dataset 222 is to be manipulated into a format according to a convolutional neural network component. The second data encoder 204 may correspond to a component that may be used for manipulating the data when the input dataset 222 is to be manipulated into a format according to a recurrent neural network component.

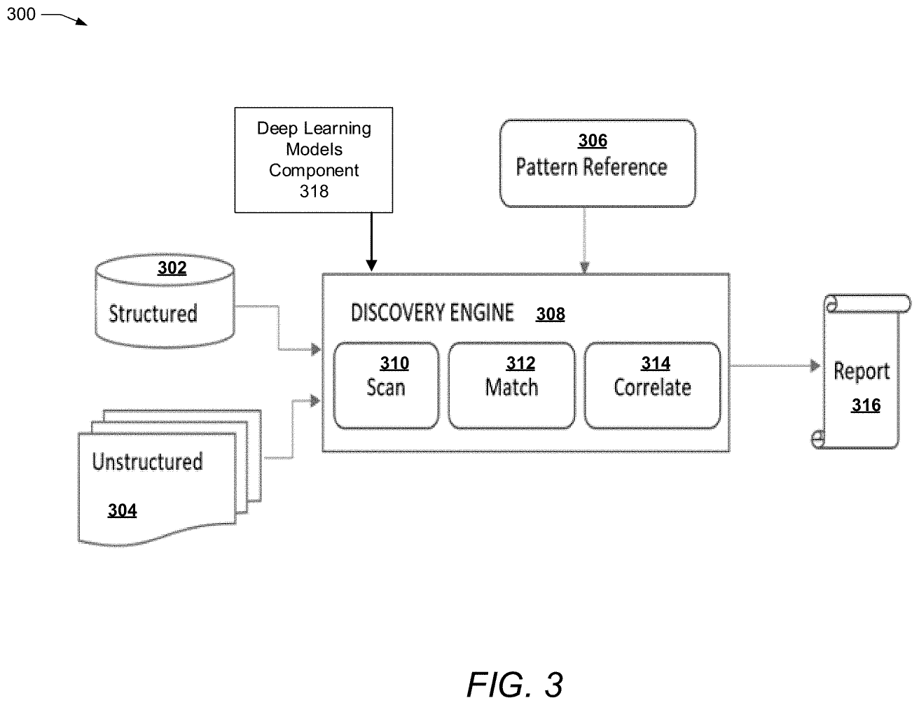

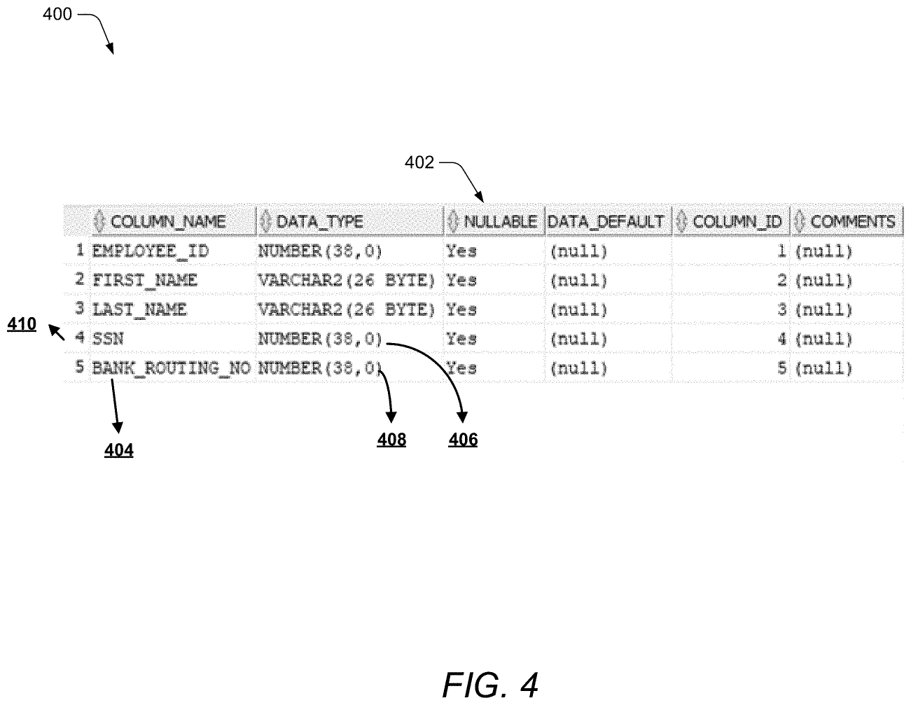

According to an example embodiment, the first data encoder 202 of the data manipulator 205 may obtain the input dataset 222. The input dataset 222 may correspond to any set of data that may be obtained from various data sources, for example, structured data sources, unstructured data sources, databases associated with enterprise systems, etc. Further, the input dataset 222 may include personal or sensitive data (e.g. data associated with an individual). In an example, the personal data may be a personal identification number of the individual. The input data set may also include other data (e.g. data that may not be associated with any individual) along with the personal data. Further, the input dataset 222 may include data that may be defined in a one-dimensional data structure. For example, the input dataset 222 may include a nine-digit social security number (SSN) or a six-digit employee identification number of an individual. More examples of the input dataset 222 are described in FIGS. 3 and 4. Further, the first data encoder 202 may convert the input dataset 222 into a formatted dataset, e.g. a dataset defined in a particular format. In some examples, the format of the formatted dataset may be defined in accordance to the type of a deep neural network component that may be selected by the neural network component selector 215.

The first data encoder 202 may include a one-hot encoding component 206 and a first dictionary 216 that may be used by the first data encoder 202 to convert the input dataset 222 into a first formatted dataset 210. For converting the input dataset 222 to the first formatted dataset 210, the first data encoder 202 may encode the input dataset 222 using the one-hot encoding component 206 and the first dictionary 216. The encoding by the one-hot encoding component 206 may correspond to a one-hot encoding technique that involves quantization of each character of the input dataset 222 by the one-hot encoding component 206, using the first dictionary 216. The first dictionary 216 may of a predefined length. For instance, in an example, the first dictionary 216 may include sixty-eight (68) characters including, twenty-six (26) English letters, ten digits (0-9), and, other special characters.

Further, based on the encoding, the first data encoder 202 may determine the first formatted dataset 210. The first formatted dataset 210 may correspond to an output provided by the first data encoder 202 that may correspond to an encoded version of the input dataset 222. The first formatted dataset 210 may be defined in a two-dimensional data structure. For instance, in an example, the first data encoder 202 may convert the input dataset 222 (e.g. a nine-digit decimal number string) defined in the one-dimensional data structure to the first formatted dataset 210 that may be defined in a two-dimensional data structure (e.g. a two-dimensional matrix of binary digits). Additionally, in an example embodiment, the first formatted dataset 210 may be one hundred and fifty bits long. Further details of the conversion of the input data set into the first formatted dataset 210 using the first dictionary 216 are described in reference to FIGS. 3-18D.

As illustrated, the data manipulator 205 of the system 200 may also include the second data encoder 204. According to an example embodiment, the second data encoder 204 of the data manipulator 205 may obtain the input dataset 222 and convert it into a second formatted dataset 218. The second data encoder 204 may convert the input dataset 222 to the second formatted dataset 218 based on an embedded matrix 208, a second dictionary 212, and a dictionary index 214. The dictionary index 214 may correspond to the second dictionary 212. The embedded matrix 208 may include a set of embedding layers of a recurrent neural network. In an example, the second data encoder 204 may also use a weight corresponding to each embedding layer of the embedded matrix 208 to convert the input dataset 222 to the second formatted dataset 218. In accordance with various embodiments of the present disclosure, the second dictionary 212 may comprise sixty-eight (68) characters, the length of the second formatted dataset 218 may be ten (10) bits, and the set of embedding layers of the embedded matrix 208 may comprise twenty-four (24) embedding layers. Further details of the conversion of the input dataset 222 into the second formatted dataset 218 are described in reference to FIGS. 3-18D.

As illustrated, the system 200 includes the neural network component selector 215. The neural network component selector 215 may identify a characteristic associated with the input dataset 222 using a predefined parameter 256. The predefined parameter 256 may be a parameter that may be used to determine a characteristic associated with data of the input dataset 222. In an example, the predefined parameter 256 may be defined by a user. In an example, the predefined parameter 256 may include a size of the input dataset and/or length of individual elements in the input dataset 222. Other examples of the predefined parameter e.g. type of data in the input dataset 222 like numeric or alphanumeric data etc. are possible. Accordingly, based on the predefined parameter, the neural network component selector 215 may identify a first characteristic data 258 associated with the input dataset 222 or a second characteristic data 260 associated with the input dataset 222. Further, based on the identified characteristics, the neural network component selector 215 may select a deep neural network component that may be used for processing the input dataset 222. For instance, in an example, the neural network component selector 215 may select a convolutional neural network component to be used for processing the input dataset 222 when the input dataset 222 is identified to be associated with the first characteristic data 258. In another example, the neural network component selector 215 may identify the input dataset 222 to be associated with the second characteristic data 260 and may select a recurrent neural network component to be used for processing the input dataset 222. More examples of the selection of the neural network component by the neural network component selector 215 according to the characteristics identified from the input dataset 222, are described further in reference to FIGS. 3-18D.

As illustrated, the system 200 may include the identification classifier 225 to identify the classification that may indicate a probability that the input dataset 222 may include sensitive data. The identification classifier 225 may include a deep neural network component 224 that may be used for processing the input dataset 222 and/or the formatted dataset by using a deep neural network (e.g. a convolutional neural network, a recurrent neural network, a long short term memory based recurrent neural network, etc.). The deep neural network component 224 may include at least, a convolutional neural network (CNN) modeler 226 and a recurrent neural network (RNN) modeler 228.

The CNN modeler 226 may include a first layer component 230, a second layer component 232, and a predefined filter 234. The CNN modeler 226 may access the first formatted dataset 210 from the first data encoder 202. The CNN modeler 226 may process the first formatted dataset 210 using the first layer component 230, the predefined filter 234, and a one-step stride. The first layer component 230 may correspond to a component that includes a first set of layers of the convolutional neural network that may be used for processing the first formatted dataset 210. In an example, the first layer component 230 may include six layers of the convolutional neural network. Further details of the processing of the first formatted dataset 210 by the first layer component 230 using the predefined filter 234 are described further in reference to FIGS. 3-18D. Based on the processing of the first formatted dataset 210 using the first layer component 230, the CNN modeler 226 may compute a first output data indicative of a one-dimensional convolution of the first formatted dataset 210. Further, the CNN modeler 226 may pass the first output data to the second layer component 232. The CNN modeler 226 may further process the first output data by using the second layer component 232. The second layer component 232 may correspond to end-to-end or fully connected layers of the artificial neural network. Based on processing the first output data by the second layer component 232, the CNN modeler 226 may compute a second output data. The second output data may correspond to the classification of the input dataset 222. In other words, the second output data may indicate a probability that a data feature of the input dataset 222 may include sensitive data. In an example, the second output data may also be stored as output data 238 by the CNN modeler 226. The working of all the components of the CNN modeler 226 may be explained in detail by way of subsequent Figs.

The RNN modeler 228 may include a Bi-Directional Long Short Term Memory (Bi-LSTM) modeler 240, an adaptive pooling layer 246, an adaptive average pooling layer 248, a concatenation layer 252, and a third layer component 254. The Bi-LSTM modeler 240 may further include a backward feedback layer component 242, and a forward feedback layer component 244. The RNN modeler 228 may process the second formatted dataset 218 by the backward feedback layer component and a forward feedback layer component of the Bi-LSTM modeler 240 to generate a third output data. The Bi-LSTM modeler 240 may deploy the backward feedback layer component 242, and the forward feedback layer component 244 to generate the third output data. As mentioned above, the second data encoder 204 may convert the input dataset 222 to the second formatted dataset 218 based on the embedded matrix 208, the second dictionary 212, and the dictionary index 214. The RNN modeler 228 may process the third output data by the adaptive pooling layer 246 function to generate a fourth output data. The RNN modeler 228 may process the third output data by the adaptive average pooling layer 248 function to generate a fifth output data. The RNN modeler 228 may concatenate the fourth output data and the fifth output data using the concatenation layer 252 function to generate a sixth output data. The RNN modeler 228 may process the sixth output data by the third layer component 254. The third layer component 254 may be a third set of layers corresponding to end-to-end connected layers of the RNN modeler 228 to generate a seventh output data indicating the classification of the input dataset 222. The seventh output data may also be stored as output dataset 250 by the RNN modeler 228. The working of all the components of the RNN modeler 228 may be explained in detail by way of subsequent Figs. The identification classifier 225 may provide the input dataset 222 to a user in a first format corresponding to the identity parameter or in a second format different than the first format. In an example, the system 110 may be configurable to automatically provide or notify the data feature of the input dataset 222 corresponding to the identity parameter to a user in the first format and another data features of the input dataset in the second format different than the first format. In accordance with various embodiments of the present disclosure, the first format and the second format may be included in the output data 238, and the output dataset 250. The system 110 may perform a pattern identification action based on the results from the output data 238, and the output dataset 250.

FIG. 3 illustrates a pictorial representation 300 of the flow of steps in the identification of sensitive data in a dataset, according to an example embodiment of the present disclosure. The identification of sensitive data in a dataset may be performed using the system 110. The dataset mentioned herein may be the input dataset 222. As mentioned above, the system 110 may be used for identifying data subject or individual's data across various databased in an organization. The system 110 may include a structured database 302, and an unstructured database 304. The system 110 may obtain the input dataset 222 from the structured database 302, and the unstructured database 304. In an example, the structured database 302 may include data sources such as Relational Database Management System (RDBMS) transactional and warehouse systems, big data, and the like. The unstructured database 304 may include unstructured data sources like Hadoop™ ecosystem and data stores like Cassandra™ Mongo™ database, etc. The unstructured database 304 may include different file types like documents, spreadsheets, presentations, zip formats, images, audio, video, mail archives and the like.

The system 110 may further include a discovery engine 308. The discovery engine 308 may scan and identify PII information spread out across the input dataset 222 obtained from the structured database 302, and the unstructured database 304. The discovery engine 308 may include a scan component 310, a match component 312, and correlate component 314. The system 110 may further include a pattern reference component 306. The pattern reference component 306 may include identifiers for universal patterns like email, phone number, SSN or other identifiers. The pattern reference component 306 may include identifiers for organization-specific personal identifiers.

The discovery engine 308 may identify data subject or individual's data across the input dataset 222 based on one or more unique representations (IDs) for the individual obtained from the structured database 302. These could be identifiers like social security numbers, email, corporate ids or organization-specific unique codes. In an example, there may be a predefined pattern included in the pattern reference component 306 that may be used to identify these unique attributes. The scan component 310 may scan the input dataset 222. The match component 312 may match the scanned input dataset 222 with a predefined pattern from the pattern reference component 306. The correlate component 314 may correlate the matched input dataset 222 to generate identification for personal information in the form of a report 316. For example, Social security numbers may typically be specified in the format “ddd-dd-dddd”. The discovery engine 308 may use a reference set of predefined patterns from the pattern reference component 306 to identify PII. The discovery engine 308 may connect to both the structured database 302 and the unstructured database 304 to scan the metadata and content of these sources using the scan component 310 and match it against pattern reference or other models using the match component 312 to identify the PII attributes. The discovery engine 308 may correlate this information using the correlate component 314 across different sources so that an on-demand report 316 can be generated specifically for each individual with all his/her PII information across the landscape.

The system 110 may further include a deep learning models component 318. The deep learning models component 318 may be coupled to the discovery engine 308. The deep learning models component 318 may be deployed by the system when the pattern identification information from the pattern reference component 306 may not effectively tag an attribute correctly as sensitive information. For example, identification of a 10-digit number as a sensitive NPI number as against all other 10-digit numbers present in an organization's data sets. The deep learning models component 318 may include the data manipulator 130, the identification classifier 140, and the neural network component selector 150. The deep learning models component 318 may recognize a new pattern from the input dataset 222 and identify the PII therefrom. The deep learning model component 318 may identify a neural network model to be used for a particular input dataset 222 based on the identification (described in detail by way of subsequent Figs.).

FIG. 4 illustrates a pictorial representation 400 of the metadata associated with a sample input dataset, according to an example embodiment of present disclosure. The input dataset illustrated by way of the pictorial representation 400 may be the metadata of the input dataset 222 obtained from the structured database 302. The pictorial representation 400 illustrates a table 402. The table 402 may be a sample database table containing two (2) definition rows namely, an SSN row 410, and a BANK_ROUTING_NO. row 404. The SSN row 410, and the BANK_ROUTING_NO. row 404 may comprise an identical type of data which may not be distinguishable. For example, the SSN row 410 may include a data type 406 that may be represented as “NUMBER (38,0)”. The BANK_ROUTING_NO. row 404 may include a data type 408 that may be represented as “NUMBER (38,0)”. As mentioned above, both the SSN and the bank routing number may be a nine (9)-digit format. The data type 406, and the data type 408 may have the same data type and data length. The deep learning models component 318 may process the data type 406, and the data type 408 for distinguishing between the SSN row 410 and the BANKROUTING_NO. row 404 for differentiating between the SSN stored in a nine (9)-digit format from all other nine (9)-digit numeric attributes such as United States (US) Bank Routing Number.

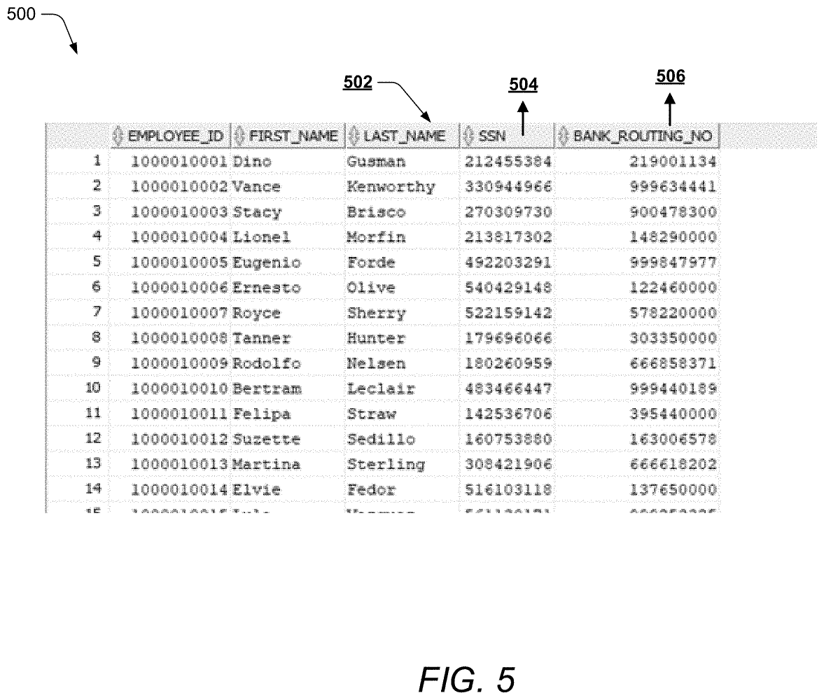

FIG. 5 illustrates a pictorial representation 500 of a sample input dataset, according to an example embodiment of present disclosure. The pictorial representation 500 illustrates detailed data samples corresponding to the metadata from the pictorial representation 400. The pictorial representation 500 illustrates a table 502. The table 502 includes an SSN column 504, and a bank routing number column 506. The data included in each row of the SSN column 504 may be in a nine (9)-digit format. The data included in each row of the bank routing number column 506 may be in a nine (9)-digit format. The deep learning models component 318 may infer various rules or patterns associated with, for example, the SSN from the data presented in the table 502 for differentiating between the SSN stored in a nine (9)-digit format from all other nine (9)-digit numeric attributes such as United States (US) Bank Routing Number. For example, the rules for SSN may include “Numbers with all zeros in any digit group (000-##-####, ###-00-####, ###-##-0000) may not be allowed”, “Numbers with 666 Or 900-999 in the first digit group may not be allowed.”, “Accepted formats: “d{3}-d{2}-d{4}” or “d{9}””. In an example, there may be no rules associated with an attribute such as US Bank Routing Number. The deep learning models component 318 may detect a pattern that a dataset may inherently possess and implement an appropriate deep learning model for identification of PII from that dataset (explained in detail by way of subsequent Figs.). For example, the deep learning models component 318 may detect a pattern for differentiating between an entry “212455384” from the SSN column 504 and an entry “219001134” from the bank routing number column 506.

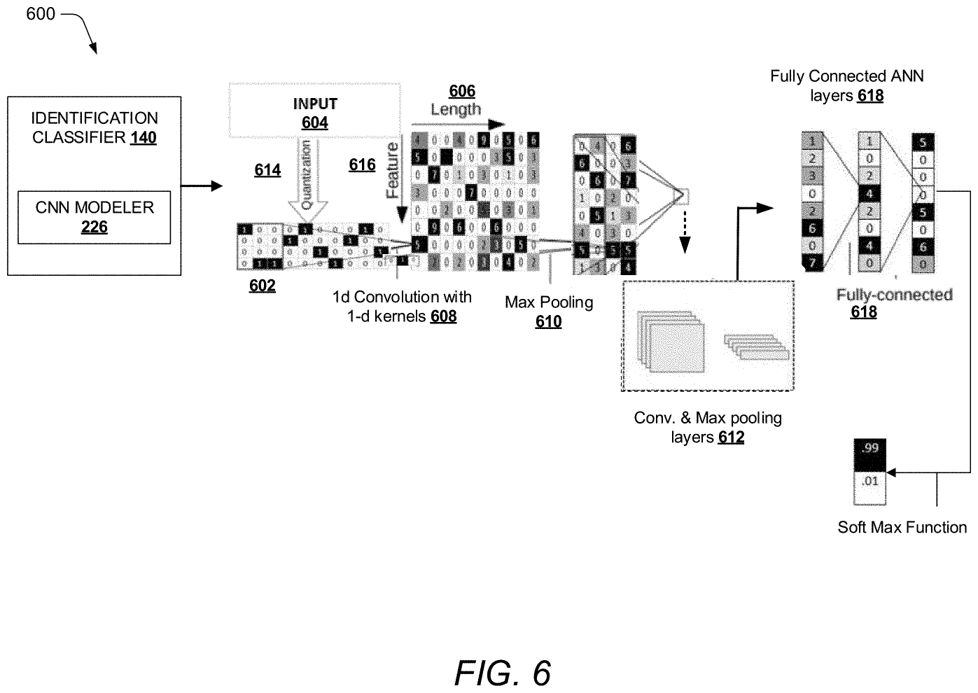

FIG. 6 illustrates a pictorial representation 600 of classification of the input dataset 222 using the convolutional neural network modeler 226 of the identification classifier 140, according to an example embodiment of present disclosure. As mentioned above, the data manipulator 130 may obtain the input dataset 222 defined in a one-dimensional data structure and convert the input dataset 222 into a formatted dataset of a two-dimensional data structure, wherein the format of the formatted dataset may be defined in accordance to a type of a deep neural network component. Also, the neural network component selector 150 may select the deep neural network based on the identification of characteristics associated with the input dataset 222 using a predefined parameter 256. The predefined parameter 256 may be a parameter that may be used to determine a characteristic associated with data of the input dataset 222. In an example, the predefined parameter 256 may be defined by a user. In an example, the predefined parameter 256 may include a size of the input dataset 222 and/or a length of individual elements in the dataset. As mentioned above, the neural network component selector 150 may select a convolutional neural network component to be used for processing the input dataset 222 when the input dataset 222 is identified to be associated with the first characteristic data 258. The pictorial representation 600 may illustrate the processing of the input dataset 222 based on the selection of the convolutional neural network component. The pictorial representation 600 illustrates the processing of the input dataset 222 by the CNN modeler 226.

As illustrated the CNN modeler 226 may include an input 604. The CNN modeler 226 may create a sequence of encoded characters as the input 604 for the CNN model. The encoding may be done by the first data encoder 202 by prescribing the first dictionary 216 of size “m” for example, as the input language. In an example, the size “m” from the first dictionary 216 may consist of sixty-eight (68) characters, including twenty-six (26) English language letters, ten (10) numeric digits ten digits (0-9) and thirty-two (32) special characters. The CNN modeler 226 may implement a quantization 614 for each character from the input 604. The quantization 614 may be implemented using one (1)-of-m encoding (or “one-hot” encoding) technique. The quantization 614 may be implemented by the one-hot encoding component 206 of the first data encoder 202. The one-hot encoding may be a process by which categorical variables may be converted into a form that could be provided to machine learning algorithms for generating a prediction. The results from the quantization 614 may be stored as an encoded matrix 602. The characters derived after the quantization 614 may be transformed into a sequence of such m sized vectors with a fixed length in the encoded matrix 602. Any character exceeding the fixed length in the encoded matrix 602 may be ignored, and any characters that may not be present in the first dictionary 216 may be quantized during the quantization 614 as all-zero vectors.

The encoded matrix 602 may be a one-dimensional convolution data structure. The encoded matrix 602 may be passed through a set of multiple one-dimensional convolutions 608, a max-pooling layer 610, and finally through fully connected Artificial Neural Network (ANN) layers 612 for classification to generate the fully connected layer 618. After each run, the system 110 may backpropagate the weights and biases across the network to adjust the kernels used in the model. The set of multiple one-dimensional convolutions 608 may include the first layer component 230, second layer component 232 associated with a set of kernels such as the predefined filter 234. The first layer component 230 may correspond to a component that includes a first set of layers of the convolutional neural network that may be used for processing the first formatted dataset 210. In an example, the first layer component 230 may include six layers of the convolutional neural network. Further details of the processing of the first formatted dataset 210 by the first layer component 230 using the predefined filter 234 are described further in reference to FIGS. 3-18D. Based on the processing of the first formatted dataset 210 using the first layer component 230, the CNN modeler 226 may compute a first output data indicative of a one-dimensional convolution of the first formatted dataset 210. Further, the CNN modeler 226 may pass the first output data to the second layer component 232. The CNN modeler 226 may further process the first output data by using the second layer component 232. The second layer component 232 may correspond to a fully connected layer of the artificial neural network implemented by the CNN modeler 226. Based on processing the first output data by the second layer component 232, the CNN modeler 226 may compute a second output data. The second output data may correspond to the classification of the input dataset 222. In other words, the second output data may indicate a probability that a data feature of the input dataset 222 may include sensitive data. In an example, the second output data may also be stored as output data 238 by the CNN modeler 226.

The set of multiple one-dimensional convolutions 608 may result in the creation of multiple feature map 606 for the encoded matrix 602. Each feature map may include a fixed length, and a feature 616. The feature 616 may be a desired characteristic for the characters present in the encoded matrix 602. The feature maps 606 may be passed through a max-pooling layer 610. The max-pooling layer 610 may include a max-pooling operation. The max-pooling operation may be a pooling operation that selects the maximum element from the region of the feature map 606 covered by the predefined filter 234. Thus, the output after max-pooling layer 610 would be the feature map 606 containing the most prominent features 616 of the previous feature map 606.

The results from the max-pooling layer 610 may be used to create an ANN layer 612 and a fully connected layer 618. The fully connected final ANN layer 618 may include the output data 238 that may correspond to the probability that a data feature of the input dataset 222 may include sensitive data that may help to distinguish for example, between a column containing an SSN from a column not containing SSN (as also illustrated by way of FIG. 4, and FIG. 5). In an example, the pictorial representation 600 may illustrate an implementation of CNN for differentiating between an entry “212455384” from the SSN column 504 and an entry “219001134” from the bank routing number column 506.

In accordance with an exemplary embodiment, the CNN modeler 226 may have a custom architecture as presented below.
“vocabulary=“abcdefghijklmnopqrstuvwxyz0123456789,;.!?:‘\”∧\|_@#$%%\hat{ }&*˜’+−=< >( )[ ]{ }”
max_length=150
batch_size=30
number_of_characters(m)=68″
   The convolutional layers have stride 1 and pooling layers are all non-overlapping ones. CNN filters:

| Layers | Small Feature | Kernel | Pool |
|---|---|---|---|
| 1 | 256 | 7 | 3 |
| 2 | 256 | 7 | 3 |
| 3 | 256 | 3 | N/A |
| 4 | 256 | 3 | N/A |
| 5 | 256 | 3 | N/A |
| 6 | 256 | 3 | 3 |

It is followed by 2 fully connected ANN Layers for classification:

| Layers | Small Feature |
|---|---|
| 7 | 1024 |
| 8 | 1024 |

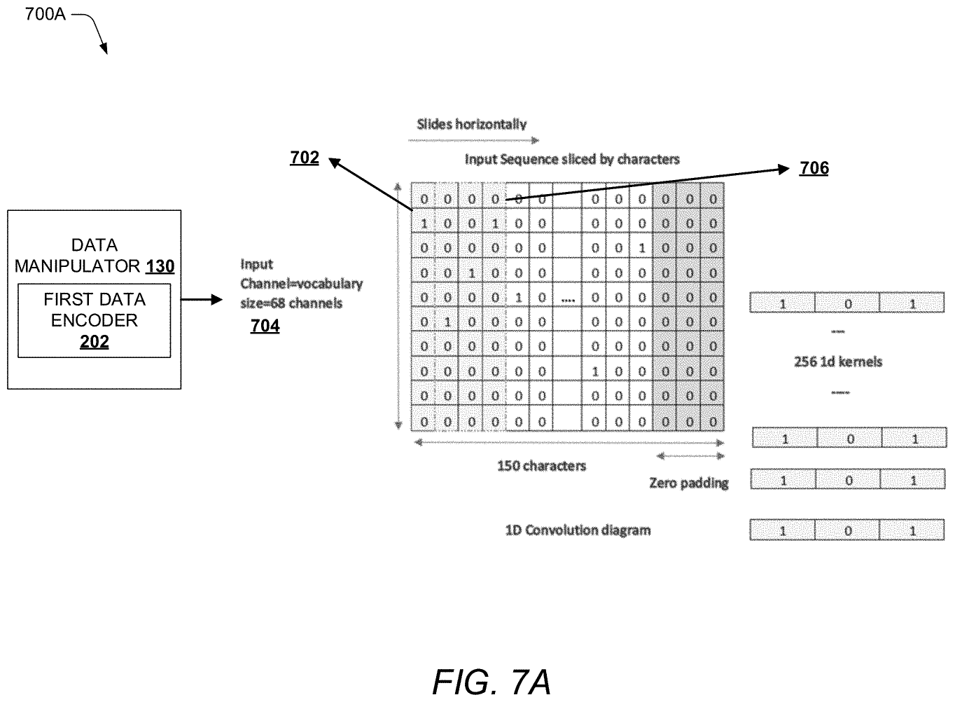

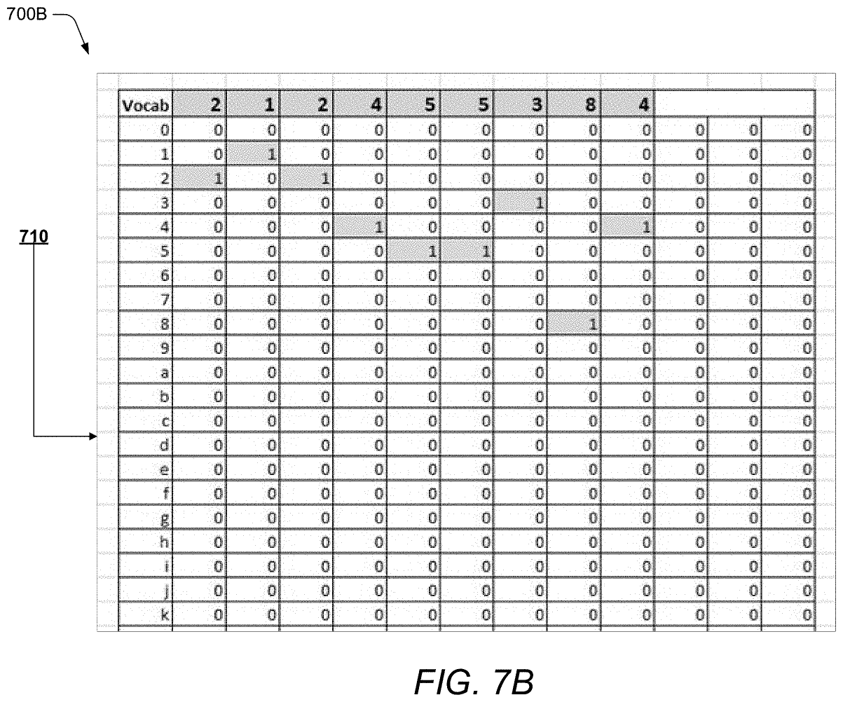

FIG. 7A illustrates a pictorial representation 700A of data manipulation by the data manipulator 130 using the first data encoder 202, according to an example embodiment of the present disclosure. FIG. 7B illustrates a pictorial representation 700B of the first formatted dataset 210 by the data manipulator 130, according to an example embodiment of the present disclosure. For the sake of brevity and technical clarity, FIGS. 7A-7B may be explained together.

As mentioned above, the first data encoder 202 may create a sequence of encoded characters as the input 604 for the CNN model. The encoded matrix 602 may be the sequence of encoded characters that may be used as the input 604 for the CNN model. The encoding may be done by the first data encoder 202 by prescribing the first dictionary 216 of size “m” for example, as the input language. In an example, the size “m” from the first dictionary 216 may consist of sixty-eight (68) characters, including 26 English language letters, 10 numeric digits and 32 special characters. The pictorial representation 700A may include a table 702. The table 702 may be an example for the encoded matrix 602. The pictorial representation 700A may further include a dictionary component 704. The dictionary component 704 may the first dictionary 216 consisting of sixty-eight (68) characters. In an example, each character from the sixty-eight (68) characters may be a channel. For example, the pictorial representation 700A may illustrate the formation of the encoded matrix 602 for the entry “212455384” from the SSN column 504.

As depicted in the FIG. 7B the first data encoder 202 may convert numeric or alphanumeric data such as the entry “212455384” from the SSN column 504 into a two (2)-dimensional dataset to create the first formatted dataset 210 that may be processed by deep learning models. In an example, as mentioned above, the one-hot encoding component 206 of the first data encoder 202 may implement the one-hot encoding for each character such as in the entry “212455384” from the SSN column 504. The first data encoder 202 may pad zeros at the end of the encoded matrix 602 to make all the numbers to a constant length of 150 as depicted by the pictorial representation 700A. After that CNN modeler 226 may implement a one (1)-dimensional convolution. The one (1)-dimensional convolution may refer to a convolution of CNN wherein the kernel (the predefined filter 234) may slide across one dimension for example, horizontally, as depicted in the pictorial representation 700B by way of a table 710. For example, the CNN modeler 226 may consider a kernel and implement a convolution in a portion 706 of the matrix. After that, the CNN modeler 226 may use a stride of one (1) so the convolution may happen after the kernel may shift horizontally by one (1) through the table 702 as depicted by the dotted portion 706 in the pictorial representation 700A.

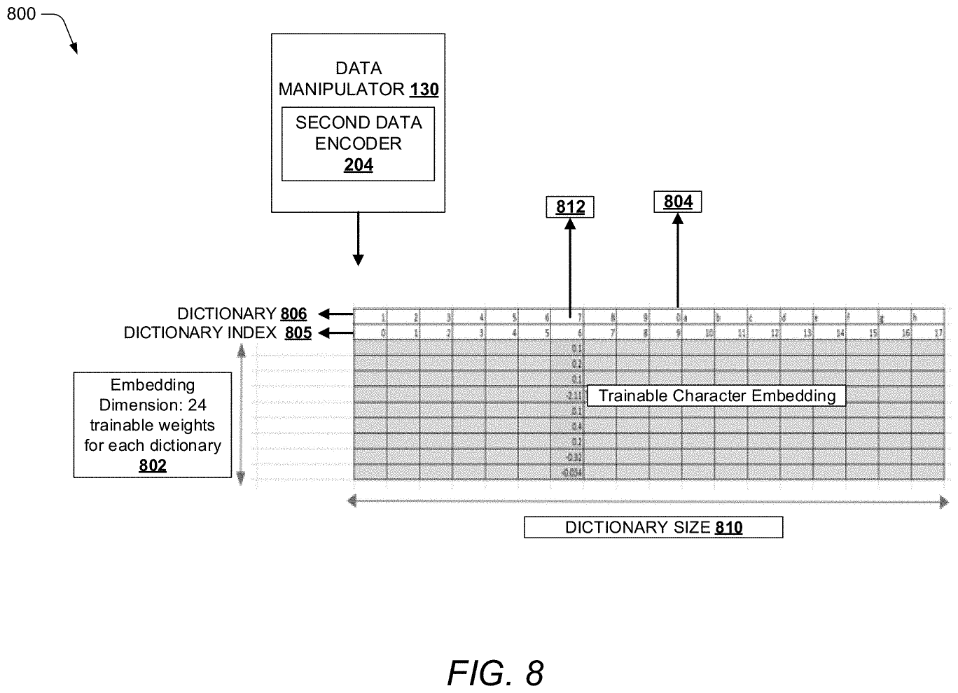

FIG. 8 illustrates a pictorial representation 800 of data manipulation of the input dataset 222 by the data manipulator 130 using the second data encoder 204, according to an example embodiment of the present disclosure. The pictorial representation 800 illustrates a matrix 804, a dictionary index 805 and a dictionary 806. The matrix 804 may correspond to the embedded matrix 208 and the dictionary index 805 may correspond to the dictionary index 214. The dictionary index 805 may include an index for each character in the dictionary 806, where each letter in a sequence is converted with the index of that character in the dictionary index 805. The dictionary 806 may have a dictionary length represented as dictionary size 810. In accordance with various embodiments of the present disclosure, the dictionary length represented 810 may comprise sixty-eight (68) characters, the length of the second formatted dataset 218 may be 10 bits, and the set of embedding layers of the embedded matrix 208 may comprise twenty-four (24) embedding layers. The pictorial representation 800 may illustrate an embedding dimension 802. The embedding dimension 802 may include twenty-four (24) embedding layers that may be twenty-four (24) trainable weights for each element in dictionary such as the second dictionary 212.

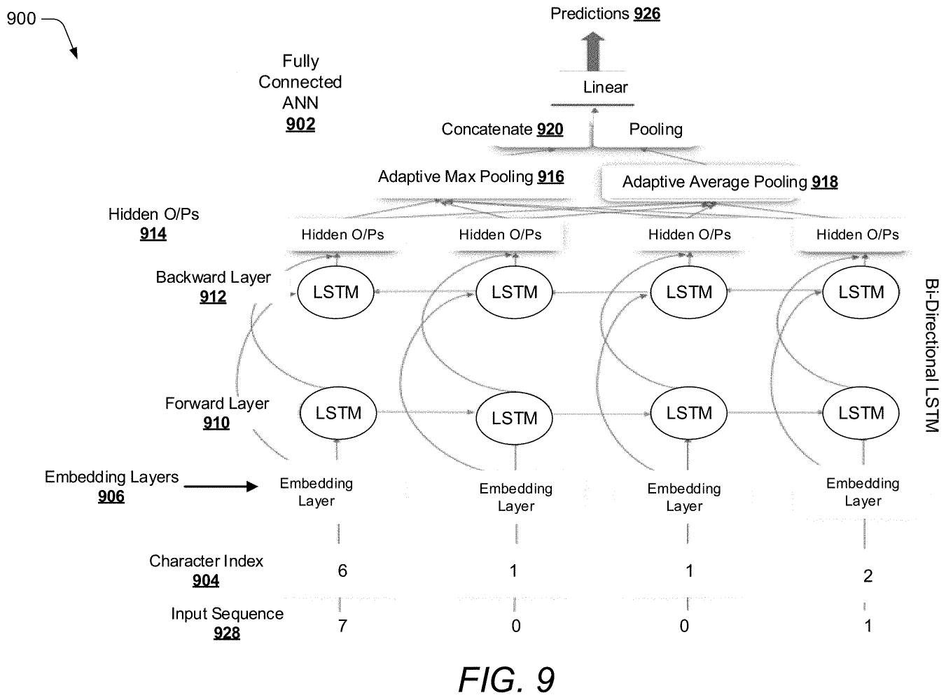

As mentioned above, there may be various data patterns that may have a sequence inherent in the pattern. For example, few of the identifiers that may be tagged as PII may have a sequential pattern such as the 5-digit US California Zip codes that may start with number nine (9) and have a sequence inherent in the pattern. Such sequential patterns may be defined by the second characteristic data 260. The RNN may have connections that may have loops, adding feedback and memory to the networks over time. This memory may allow this type of network to learn and generalize across sequences of inputs rather than individual patterns. Therefore, for identifying PII with a sequential pattern, the neural network component selector 150 may select the RNN modeler 228. The RNN modeler 228 may include implementation of techniques such as the Seq2Seq (Many to Many) RNN approach including implementation of the Bi-LSTM to identify and tag identifiers such as zip-code values. This approach may be used because of a feedback loop in RNN architecture and for each individual character, the LSTM model may predict the next individual character in the sequence. This may facilitate learning the hidden patterns present across the entire data sequence. The advantage of using any RNN model may be to have the output as a result of not only a single item independent of other items, but rather a sequence of items. The output of the layer's operation on one item in the sequence is the result of both that item and any item before it in the sequence. The pictorial representation 800 may represent the embedded matrix 208 for the dictionary index 214. In the LSTM model, these character embeddings may be passed for training. For instance, in FIG. 9 (described below) for the first bidirectional LSTMs, the RNN modeler 228 may be passing the embeddings for vocabulary element “7” which may be equal to a column 812 in FIG. 8. The column 812 may be a (1*24) tensor size that may be passing to the first LSTM. The embedded matrix 208 may work with a smaller dimension vector space which may replace the original one hot encoding matrix and helps in faster computation.

FIG. 9 illustrates a pictorial representation 900 of the classification of an input dataset using a recurrent neural network modeler of an identification classifier, according to an example embodiment of present disclosure. In an example, the neural network component selector 150 may identify the input dataset 222 to be associated with the second characteristic data 260 and may select a recurrent neural network component to be used for processing the input dataset 222. The classification of an input dataset illustrated in FIG. 9 may be based on the data present in the column 812.

The second dictionary 212 used in the model processing for model depicted in the pictorial representation 900 consists of sixty-eight (68) characters including, twenty-six (26) English letters, ten digits (0-9), and, other special characters. An input sequence 928 with a fixed-length sequence of for example, “10” may be passed to the model every time. Any letter exceeding the predefined sequence length may be ignored. For a shorter sequence, the sequence may be converted into the fixed-length sequence by zero padding at the end. The model may convert each letter in the sequence with a character index 904. The character index 904 may be a character from the second dictionary 212 corresponding to each letter in the sequence. The model may create an embedding layer 906 at each position of the record for the dictionary size 810.

After conversion, that data may be passed through a 2-layer Bidirectional LSTM. The 2-layer Bidirectional LSTM may be implemented by the Bi-LSTM modeler 240. The Bi-LSTM modeler 240 may include a forward layer 910, and the backward layer 912. The forward layer 910 may be the forward feedback layer component 244. The backward layer 912 may be the backward feedback layer component 242. Each encode letter in each record may be passed through the forward layer 910, and the backward layer 912 from the Bi-LSTM modeler 240 parallelly using, for example, the pack_padded_sequence approach in Pytorch™. This approach may help in minimizing the computations due to the padding and hence reduces the training time and improve performance. The Bi-LSTM modeler 240 may run input sequence in two ways, one from past to future (forward layer 910) and one from future to past (the backward layer 912). Therefore, using the two hidden states combined the RNN modeler 228 may be able to at any point in time preserve pattern information from both past and future simultaneously.

The outputs at each position of all the timesteps along with a last hidden state output 914 may be taken together to create a concatenated pooling layer 920. The concatenated pooling layer 920 may include an adaptive average pooling 918 and adaptive max-pooling layer 916. The concatenated pooling may refer to taking max and average of the output of all timesteps and then concatenating them along with the last hidden state output 914. The RNN modeler 228 may not consider the padding which was added for each individual sequence to make them of equal length for creating the concatenated pooling layer 920. This removes unwanted biases due to zero padding. This approach may facilitate improvement in accuracy. The output from the concatenated pooling layer 920 may be fed to a fully connected Artificial Neural Network (ANN) 902 for classification and generating predictions 926. The predictions 926 may be the identification of PII from the input dataset 222. The model parameters get backpropagated through the entire network across the hidden states and cell states and the embedding character layer weights at each position get adjusted accordingly. In an example, this model may work well even with relatively small datasets and may be able to distinguish the identifiers with an inherent pattern such as zip code column from the other numeric columns of similar length.

The RNN model with concatenated pooling layer 920 may include the hidden pattern to be present across the data sequence so the hidden outputs 914 may be determined from each timestep along with the last hidden output of the sequence before it may be passed through fully connected ANN layers 902 for classification. The RNN model with concatenated pooling layer 920 may create the concatenated pooling layers 920 by considering the outputs for the actual sequence length and remove the zero-padding for removing unwanted biases. The adaptive average pooling 918 and adaptive max-pooling layers 916 may help to generalize and interpolate between mean and maximum values.

In accordance with an exemplary embodiment, the RNN modeler 228 may have a custom architecture as presented below:
“vocabulary=“abcdefghijklmnopqrstuvwxyz0123456789,;.!?:‘\”∧\|_@#$%%\hat{ }&*˜‘+−=< >( )[ ]{ }”
max_length=10
batch_size=32
number_of_characters(m)=68
embedding layer=24
hidden size=12
No of Bi-directional LSTM layers=2″

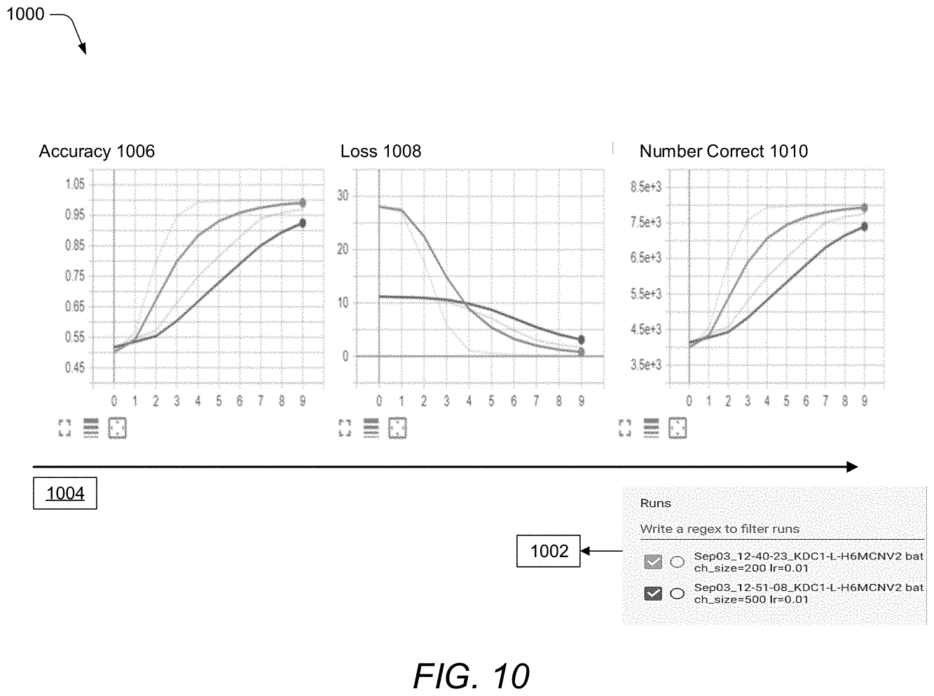

FIG. 10 illustrates a pictorial representation 1000 of plots representing loss and accuracy graphs for classification performed based on a set of epochs, by the identification classifier 140, using the convolutional neural network modeler 226, in accordance with an example implementation of the present disclosure. The pictorial representation 1000 illustrates an accuracy 1006, a total loss 1008 and a total number of correct predictions 1010 for a training set changing across a set of ten (10) epochs 1004. This comparison may be for sample two (2) sets with a batch size of 500 and 200 respectively and the learning rate may be 0.01. The pictorial representation 1000 further illustrates a legend 1002 corresponding to the accuracy 1006, the total loss 1008, and the total number of correct predictions 1010.

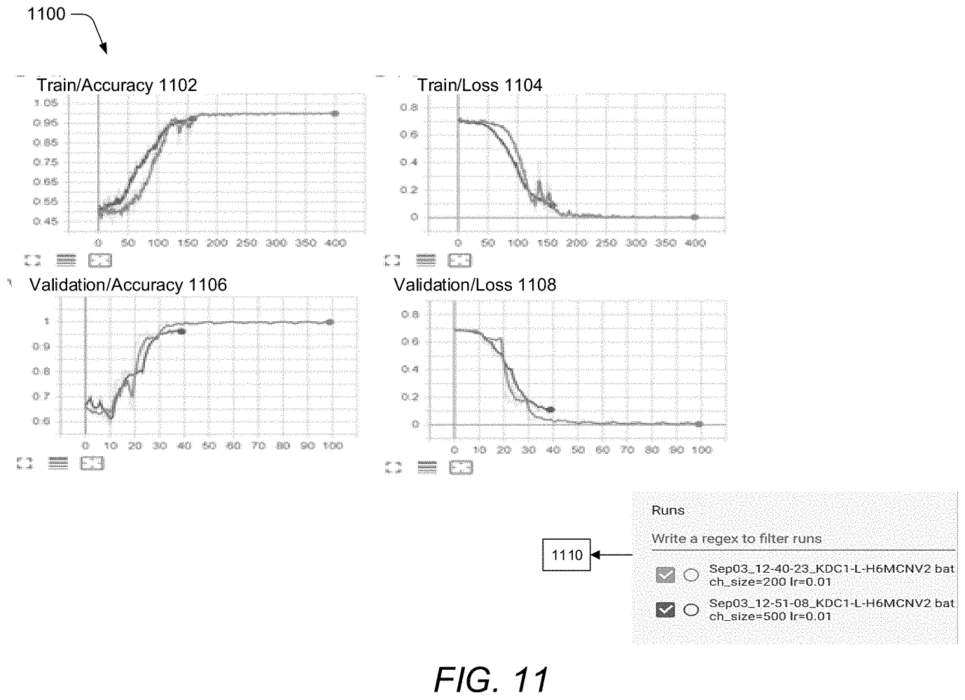

FIG. 11 illustrates a pictorial representation 1100 of plots representing loss and accuracy graphs for classification performed on training and validation datasets, by the identification classifier 140, using the convolutional neural network modeler 226, in accordance with another example implementation of the present disclosure. The pictorial representation 1100 illustrates a training accuracy 1102, a training loss 1104, a validation accuracy 1106, and a validation loss 1108 for a training set changing across a set of ten (10) epochs 1004. This comparison may be for sample two (2) sets with a batch size of 500 and 200 respectively. The pictorial representation 1100 further illustrates a legend 1110 corresponding to the training accuracy 1102, the training loss 1104, the validation accuracy 1106, and the validation loss 1108.

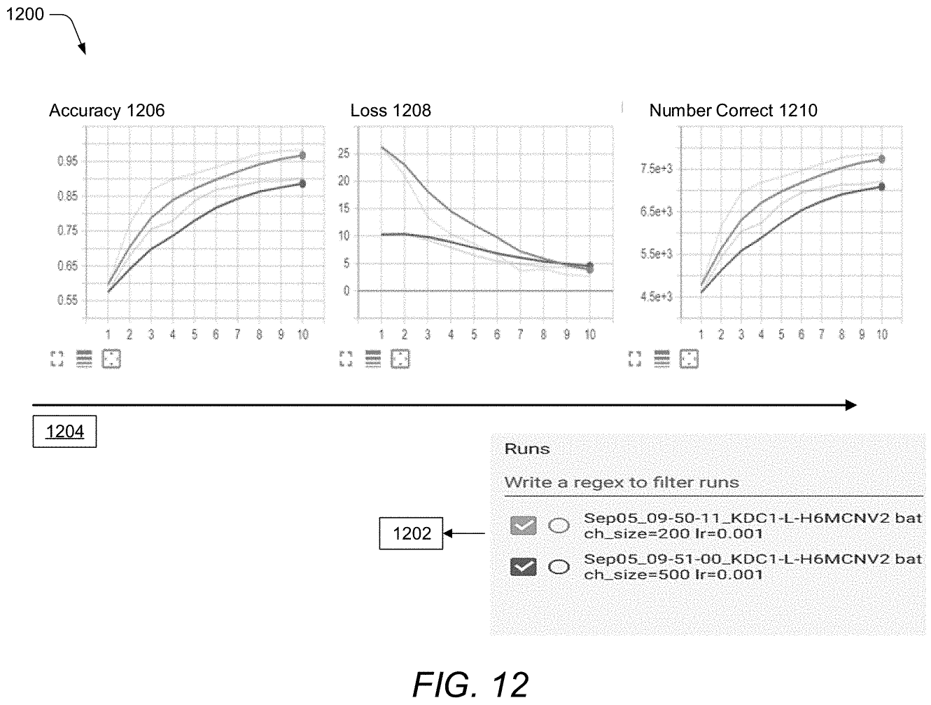

FIG. 12 illustrates a pictorial representation 1200 of plots representing loss and accuracy graphs for classification performed based on a set of epochs performed by the identification classifier 140 using the recurrent neural network modeler 228, in accordance with an example implementation of the present disclosure. The pictorial representation 1200 illustrates an accuracy 1206, a total loss 1208 and a total number of correct predictions 1210 for a training set changing across a set of ten (10) epochs 1204. This comparison may be for sample two (2) sets with a batch size of 500 and 200 respectively and the learning rate may be 0.001. The pictorial representation 1200 further illustrates a legend 1202 corresponding to the accuracy 1206, the total loss 1208 and the total number of correct predictions 1210.

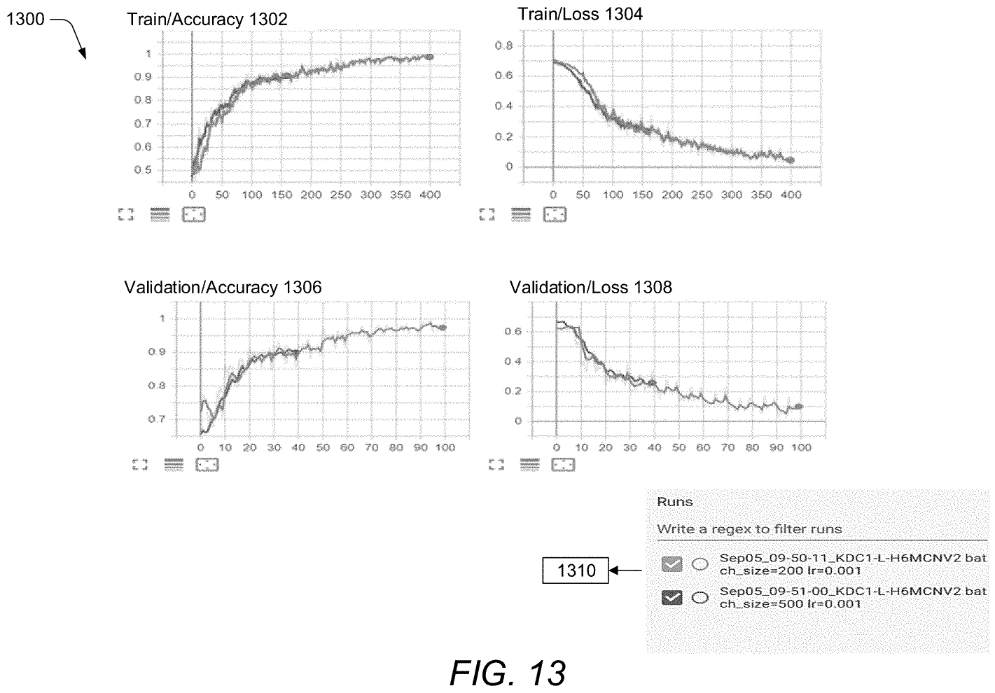

FIG. 13 illustrates a pictorial representation 1300 of plots representing loss and accuracy graphs for classification performed on training and validation datasets by the identification classifier 140 using the recurrent neural network modeler 228, in accordance with another example implementation of the present disclosure. The pictorial representation 1300 illustrates a training accuracy 1302, a training loss 1304, a validation accuracy 1306, and a validation loss 1308 for a training set changing across a set of ten (10) epochs. This comparison may be for sample two (2) sets with a batch size of 500 and 200 respectively. The pictorial representation 1300 further illustrates a legend 1310 corresponding to the training accuracy 1302, the training loss 1304, the validation accuracy 1306, and the validation loss 1308.

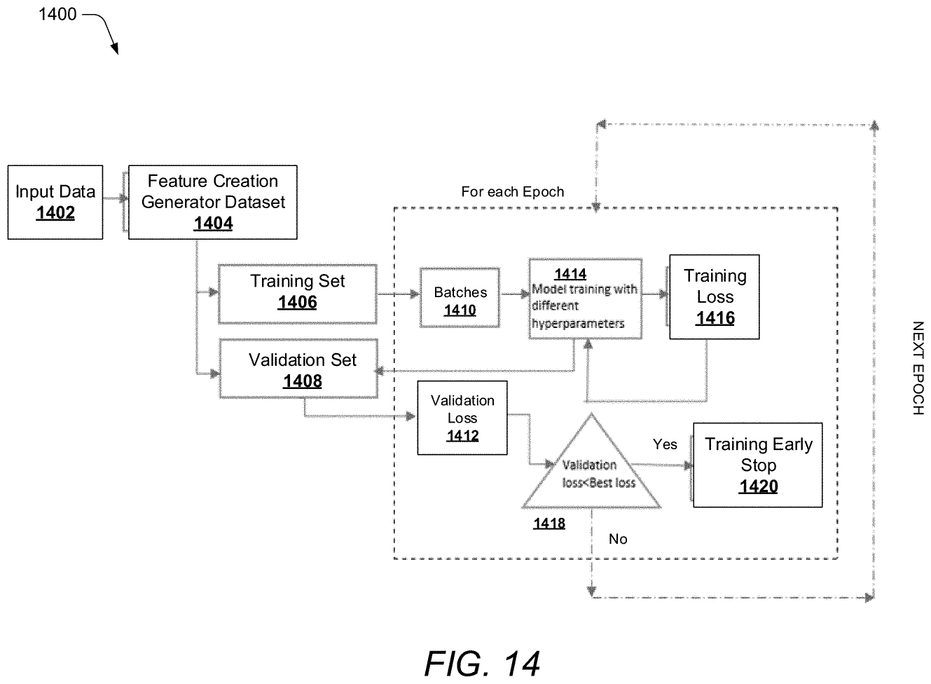

FIG. 14 illustrates process flowchart 1400 for the model training for classification of the input dataset 222 by the identification classifier 140, according to an example embodiment of present disclosure. The process flowchart 1400 may include an input data 1402. The input data 1402 may be the input dataset 222 that may be required to be tagged. The input data 1402 may be processed through a feature creation generator dataset 1404. The feature creation generator dataset 1404 may split the input data 1402 into a training set 1406 and a validation set 1408. The identification classifier 140 may use the training set 1406 to train the neural network model such as the RNN, or the CNN as selected by the neural network component selector 150. The validation set 1408 may also include a validation loss 1412 (also depicted by FIG. 11 and FIG. 13). The training set 1406 may be trained in a set of batches 1410. Thereafter, a set of optimal hyperparameters 1414 may be selected. The set of optimal hyperparameters 1414 may be selected to minimize the validation loss 1412. The set of optimal hyperparameters 1414 may be selected to may minimize a training loss 1416 (also depicted by FIG. 11 and FIG. 13). The identification classifier 140 may perform a check 1418. The check 1418 may check for the validation loss 1412 may be less than a minimum validation loss. In an example, the check 1418 may be affirmative, the identification classifier 140 may execute a termination 1420 to stop the training for the training set 1406. In another example, the check 1418 may be negative, the identification classifier 140 may continue with the training for the training set 1406 until the check 1418 may be affirmative.

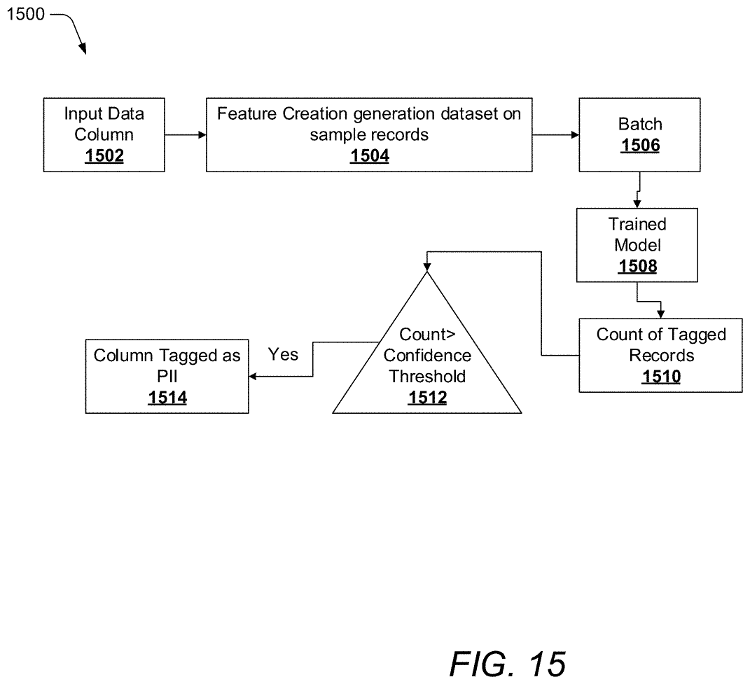

FIG. 15 illustrates process flowchart 1500 for classification of a structured dataset such as the structured dataset 302 by the identification classifier 140, according to an example embodiment of present disclosure. The trained model from FIG. 14 may be used to tag PII information in structured data sources such as RDBMS. In the case of the structured dataset 302, a column of the table such as an input data column 1502 may be checked to ascertain whether it's may include a PII or not. In an example, a set of sampled column values 1504 may be feature engineered and made into a set of batches 1506. The set of batched 1506 may be passed through a model 1508. The model 1508 may be the trained model from FIG. 14. In an example, the model 1508 may be a CNN. In another example, the model 1508 may be an RNN. The identification classifier 140 may perform a count operation 1510, wherein a number of tagged records may be counted. The results from the model 1508 may be compared against a configurable threshold 1512 to decide whether to tag the entire column as PII or not. If the number of tagged records may be greater than the configurable threshold 1512, the identification classifier 140 may execute a tagging 1514, wherein the entire column may be tagged as PII.

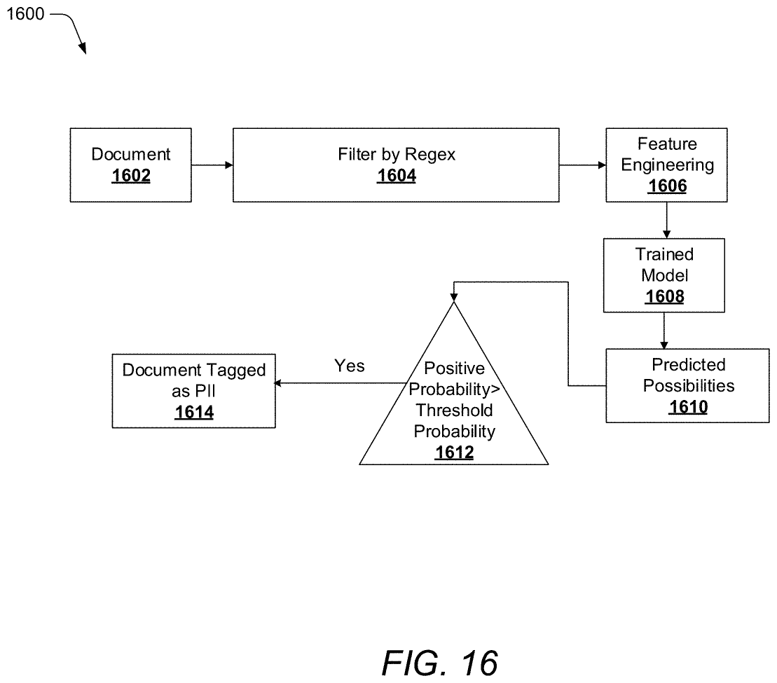

FIG. 16 illustrates process flowchart 1600 for classification of an unstructured dataset by an identification classifier, according to an example embodiment of present disclosure. The trained model from FIG. 14 may be used to tag PII information in documents or unstructured files. For unstructured files or documents 1602, the value from the content may be filtered by a regular expression 1604 and then passed through a feature engineering model 1606. The output from the feature engineering model 1606 may then be passed to a trained model 1608. The model 1608 may be the trained model from FIG. 14. In an example, the model 1608 may be a CNN. In another example, the model 1608 may be an RNN. The identification classifier 140 may execute an analysis 1610, wherein the prediction possibilities may be analyzed. The results from the analysis 1610 may be compared against a configurable threshold 1612 to decide whether to tag value as PII or not. If the number of prediction possibilities may be greater than the configurable threshold 1612, the identification classifier 140 may execute a tagging 1614, wherein a value from a document may be tagged as PII.

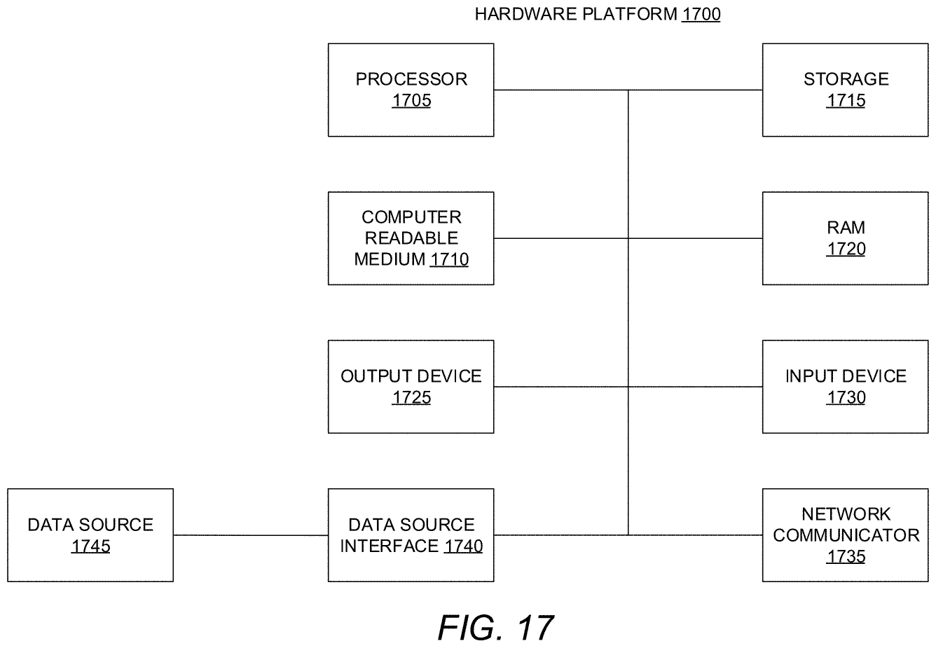

FIG. 17 illustrates a hardware platform 1700 for implementation of the system 110, according to an example embodiment of the present disclosure. For the sake of brevity, construction and operational features of the system 110 which are explained in detail above are not explained in detail herein. Particularly, computing machines such as but not limited to internal/external server clusters, quantum computers, desktops, laptops, smartphones, tablets and wearables which may be used to execute the system 110 or may have the structure of the hardware platform 1700. The hardware platform 1700 may include additional components not shown and that some of the components described may be removed and/or modified. In another example, a computer system with multiple GPUs can sit on external-cloud platforms including Amazon Web Services, or internal corporate cloud computing clusters, or organizational computing resources, etc.

The hardware platform 1700 may be a computer system 1700 that may be used with the examples described herein. The computer system 1700 may represent a computational platform that includes components that may be in a server or another computer system. The computer system 1700 may execute, by a processor (e.g., a single or multiple processors) or other hardware processing circuit, the methods, functions and other processes described herein. These methods, functions and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system 1700 may include a processor 1705 that executes software instructions or code stored on a non-transitory computer-readable storage medium 1710 to perform methods of the present disclosure. The software code includes, for example, instructions to gather data and documents and analyze documents. In an example, the data manipulator 130, the identification classifier 140, and the neural network component selector 150 may be software codes or components performing these steps.

The instructions on the computer-readable storage medium 1710 are read and stored the instructions in storage 1715 or in random access memory (RAM) 1720. The storage 1715 provides a large space for keeping static data where at least some instructions could be stored for later execution. The stored instructions may be further compiled to generate other representations of the instructions and dynamically stored in the RAM 1720. The processor 1705 reads instructions from the RAM 1720 and performs actions as instructed.

The computer system 1700 further includes an output device 1725 to provide at least some of the results of the execution as output including, but not limited to, visual information to users, such as external agents. The output device can include a display on computing devices. For example, the display can be a mobile phone screen or a laptop screen. GUIs and/or text are presented as an output on the display screen. The computer system 1700 further includes input device 1730 to provide a user or another device with mechanisms for entering data and/or otherwise interact with the computer system 1700. The input device may include, for example, a keyboard, a keypad, a mouse, or a touchscreen. Each of these output devices 1725 and input devices 1730 could be joined by one or more additional peripherals. In an example, the output device 1725 may be used to display the results in the first format that may be indicative of sensitive data.

A network communicator 1735 may be provided to connect the computer system 1700 to a network and in turn to other devices connected to the network including other clients, servers, data stores, and interfaces, for instance. A network communicator 1735 may include, for example, a network adapter such as a LAN adapter or a wireless adapter. The computer system 1700 includes a data source interface 1740 to access data source 1745. A data source is an information resource. As an example, a database of exceptions and rules may be a data source. Moreover, knowledge repositories and curated data may be other examples of data sources.

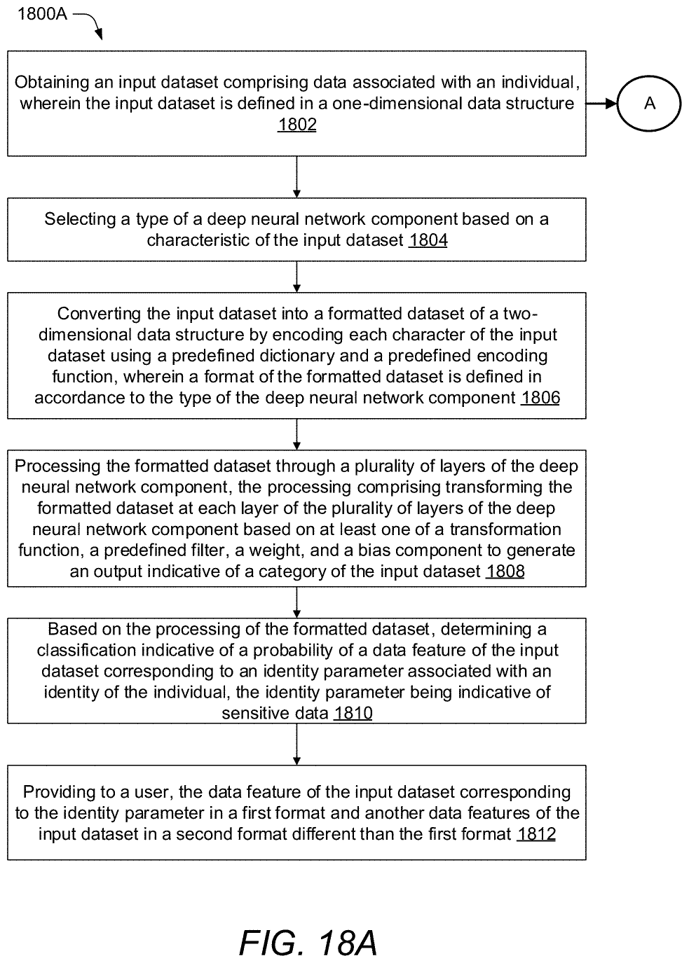

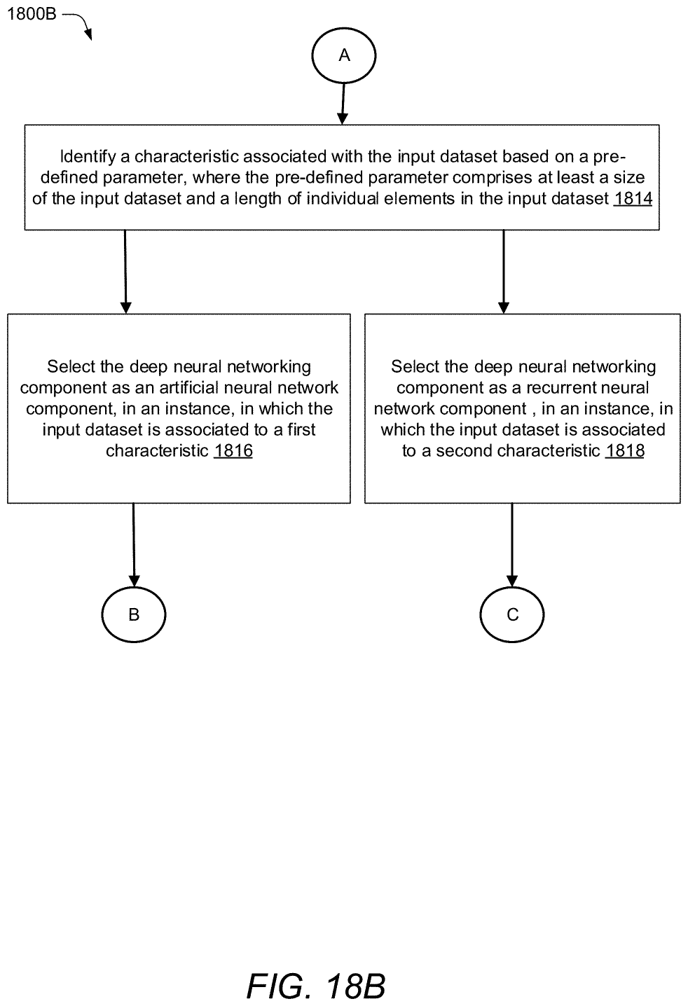

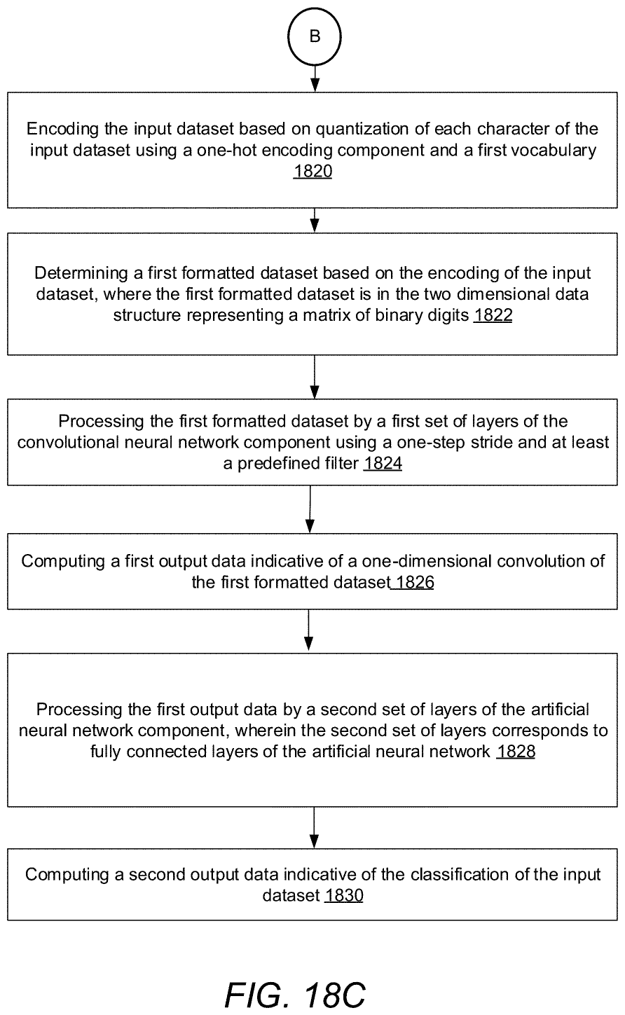

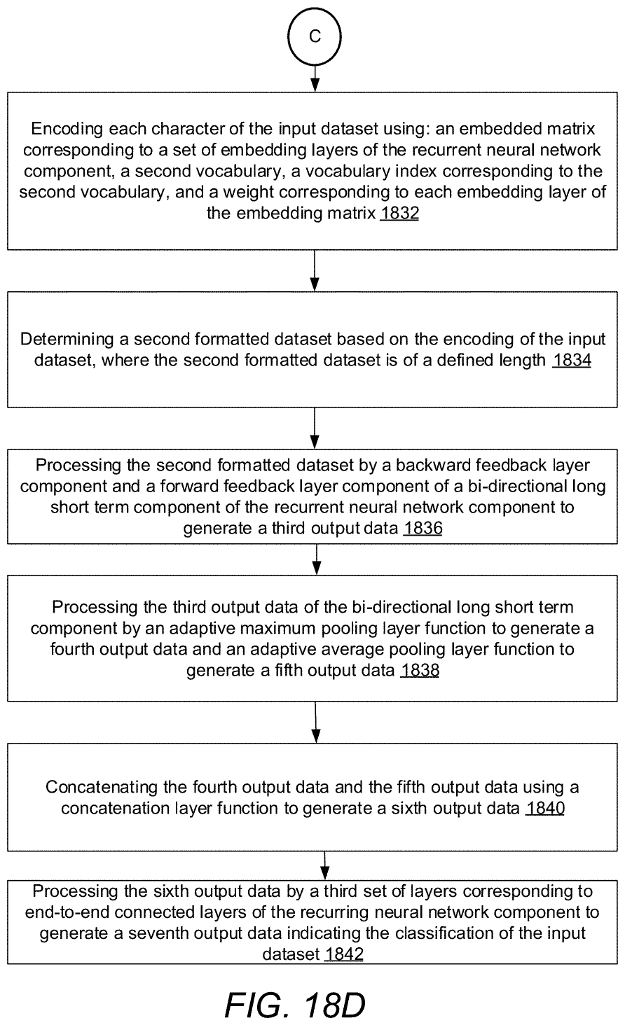

FIGS. 18A-18D illustrate a process flowchart for the system 110 for determining classification for an input dataset 222, according to an example embodiment of the present disclosure. It should be understood that method steps are shown here for reference only and other combinations of the steps may be possible. Further, the method 1800 may contain some steps in addition to the steps shown in FIG. 18. For the sake of brevity, construction and operational features of the system 110 which are explained in detail in the description of FIGS. 1-17 are not explained in detail in the description of FIG. 18. The method 1800 may be performed by a component of the system 110.

At block 1802, an input dataset, such as the input data set 222 may be obtained comprising data associated with an individual, wherein the input dataset 222 is defined in a one-dimensional data structure.

At block 1804, the input dataset may be converted into the formatted dataset of a two-dimensional data structure, wherein a format of the formatted dataset is defined in accordance with a type of a deep neural network component. In an example, a type of the deep neural network component may be selected based on a characteristic of the input dataset. The deep neural network component may be, for example, a convolutional neural network component or a recurrent neural network component

At block 1806, the formatted dataset may be processed by the deep neural network component. The processing may include transforming the formatted dataset at each layer of the plurality of layers of the deep neural networking component based on at least one of a transformation function, a predefined filter, a weight, and a bias component to generate an output indicative of a category of the input dataset.

At block 1808, a classification may be determined, the classification may be indicative of a probability of an input dataset to correspond to a personal identifier, which may represent sensitive data associated with an individual.

At block 1810, based on the processing of the formatted dataset a classification may be determined indicative of a probability of a data feature of the input dataset corresponding to an identity parameter associated with an identity of the individual. The identity parameter may be indicative of sensitive data.

At block 1812, the data feature of the input dataset corresponding to the identity parameter in a first format may be provided to a user and another data features of the input dataset in a second format different than the first format may be provided to the user.

Referring to FIG. 18B, at block 1814, a characteristic may be identified associated with the input dataset based on a predefined parameter, where the predefined parameter comprises at least of a size of the input dataset and/or a length of individual elements in the dataset.

The block 1814, branches to block 1816, when the input dataset is associated to a first characteristic. At block 1816, the deep neural network component may be selected as the convolutional neural network component.

The block 1814, branches to block 1818, when the input dataset is associated to a second characteristic. At block 1818, the deep neural network component may be selected as the recurrent neural network component.

Referring to FIG. 18C, the block 1816 proceeds to block 1820, where the input dataset may be encoded based on the quantization of each character of the input dataset using a one-hot encoding component and a first vocabulary.

At block 1822, a first formatted dataset may be determined based on the encoding of the input dataset, where the first formatted dataset is in the two-dimensional data structure representing a matrix of binary digits.

At block 1824, the first formatted dataset may be processed by a first set of layers of the convolutional neural network component using a one-step stride and at least a predefined filter.

At block 1826, the first output data may be computed indicative of a one-dimensional convolution of the first formatted dataset.

At block 1828, the first output data may be processed by the second set of layers of the artificial neural network component, where the second set of layers corresponds to fully connected layers of the artificial neural network.

At block 1830, the second output data may be computed indicative of the classification of the input dataset 222.

Referring to FIG. 18D, the block 1818 of FIG. 18B proceeds to block 1832, where each character of the input dataset 222 may be encoded using: an embedded matrix corresponding to a set of embedding layers of the recurrent neural network component, a second vocabulary, a vocabulary index corresponding to the second vocabulary, and a weight corresponding to each embedding layer of the embedding matrix.

At block 1834, a second formatted dataset may be determined based on the encoding of the input dataset 222, where the second formatted dataset is of a predefined length.

At block 1836, the second formatted dataset may be processed by a backward feedback layer component and a forward feedback layer component of a bi-directional long short term component of the recurrent neural network component to generate a third output data

At block 1838, the third output data of the bi-directional long short term component may be processed by an adaptive maximum pooling layer function to generate a fourth output data and an adaptive average pooling layer function to generate a fifth output data

At block 1840, the fourth output data and the fifth output data may be concatenated using a concatenation layer function to generate a sixth output data.

At block 1842, the sixth output data may be processed by the third set of layers corresponding to end-to-end connected layers of the recurrent neural network component to generate a seventh output data indicating the classification of the input dataset.

In an example, the method 1800 may be practiced using a non-transitory computer-readable medium. In an example, the method 1800 may be computer-implemented.

The present disclosure provides for a system for PII tagging that may generate key insights related to PII pattern identification with minimal human intervention. Furthermore, the present disclosure may deduce a mechanism of modifying a data identification technique, in near real-time, based on the identification of unrecognized patterns and the associated characteristics in the dataset.

One of ordinary skill in the art will appreciate that techniques consistent with the present disclosure are applicable in other contexts as well without departing from the scope of the disclosure.

What has been described and illustrated herein are examples of the present disclosure. The terms, descriptions, and figures used herein are set forth by way of illustration only and are not meant as limitations. Many variations are possible within the spirit and scope of the subject matter, which is intended to be defined by the following claims and their equivalents in which all terms are meant in their broadest reasonable sense unless otherwise indicated.

1. A system comprising:
a processor;
a data manipulator coupled to the processor, the data manipulator to:
obtain an input dataset comprising data associated with an individual, wherein the input dataset is defined in a one-dimensional data structure;
select a type of a deep neural network component based on a characteristic of the input dataset; and
convert the input dataset into a formatted dataset of a two-dimensional data structure by encoding each character of the input dataset using a predefined dictionary and a predefined encoding function, wherein a format of the formatted dataset is defined in accordance to the type of the deep neural network component; and
an identification classifier coupled to the processor, the identification classifier to:
process the formatted dataset through a plurality of layers of the deep neural network component, the processing comprising transforming the formatted dataset at each layer of the plurality of layers of the deep neural network component based on at least one of a transformation function, a predefined filter, a weight, and a bias component to generate an output indicative of a category of the input dataset;
based on the processing of the formatted dataset determine a classification indicative of a probability of a data feature of the input dataset corresponding to an identity parameter associated with an identity of the individual, the identity parameter being indicative of sensitive data; and
provide to a user the data feature of the input dataset corresponding to the identity parameter in a first format and another data features of the input dataset in a second format different than the first format.

2. The system as claimed in claim 1, further comprising a neural network component selector coupled to the processor to:
identify a characteristic associated with the input dataset based on a pre-defined parameter, where the pre-defined parameter comprises at least a size of the input dataset and/or length of individual elements in the dataset;
select the type of the deep neural network component as a convolutional neural network component, when the input dataset is associated to a first characteristic; and
select the deep neural network component as a recurrent neural network component when the input dataset is associated to a second characteristic.

3. The system as claimed in claim 2, wherein the first characteristic indicates the size of the input dataset being less than a predetermined size and the second characteristic indicates the size of the input dataset being greater than a predetermined size.

4. The system as claimed in claim 2, further comprising:
a first data encoder coupled to the processor to:
encode the input dataset based on quantization of each character of the input dataset using a one-hot encoding component and a first dictionary; and
determine a first formatted dataset based on the encoding of the input dataset, wherein the first formatted dataset is in the two-dimensional data structure representing a matrix of binary digits; and
a convolutional neural network modeler coupled to the processor, the convolutional network modeler comprising a first set of layers and a second set of layers to:
process the first formatted dataset by the first set of layers of the convolutional neural network component using a one-step stride and at least a predefined filter;
based on the processing of the first formatted dataset, compute a first output data indicative of a one-dimensional convolution of the first formatted dataset;
process the first output data by the second set of layers of the convolutional neural network component, wherein the second set of layers corresponds to fully connected layers of the artificial neural network; and
based on processing of the first output data, compute a second output data indicative of the classification of the input dataset.

5. The system as claimed in claim 4, wherein the first dictionary comprises sixty-eight characters, the first set of layers comprises six layers, the second set of layers comprises two layers, and the first formatted dataset is one hundred and fifty bits long.

6. The system as claimed in claim 2, further comprising a second data encoder coupled to the processor, the second data encoder to:
encode each character of the input dataset using an embedded matrix corresponding to a set of embedding layers of the recurrent neural network component, a second dictionary, a dictionary index corresponding to the second dictionary, and a weight corresponding to each embedding layer of the embedding matrix; and
determine a second formatted dataset based on the encoding of the input dataset, wherein the second formatted dataset is of a predefined length.

7. The system as claimed in claim 6, further comprising a recurrent neural network modeler coupled to the processor, the recurrent neural network modeler comprising a bi-directional long short term memory modeler, the recurrent neural network modeler to:
process the second formatted dataset by a backward feedback layer component and a forward feedback layer component of the bi-directional long short term component to generate a third output data;
process the third output data of the bi-directional long short term component by an adaptive maximum pooling layer function to generate a fourth output data and an adaptive average pooling layer function to generate a fifth output data;
concatenate the fourth output data and the fifth output data using a concatenation layer function to generate a sixth output data; and
process the sixth output data by a third set of layers corresponding to end-to-end connected layers of the recurrent neural network component to generate a seventh output data indicating the classification of the input dataset.

8. The system as claimed in claim 6, wherein the second dictionary comprises sixty eight characters, the second formatted dataset is ten bits long, and the set of embedding layers comprises twenty four embedding layers.

9. A method comprising:
obtaining, by a processor, an input dataset comprising data associated with an individual, wherein the input dataset is defined in a one-dimensional data structure;
selecting, by the processor, a type of a deep neural network component based on a characteristic of the input dataset;
converting, by the processor, the input dataset into a formatted dataset of a two-dimensional data structure by encoding each character of the input dataset using a predefined dictionary and a predefined encoding function, wherein a format of the formatted dataset is defined in accordance to the type of the deep neural network component;
processing, by the processor, the formatted dataset through a plurality of layers of the deep neural network component, the processing comprising transforming the formatted dataset at each layer of the plurality of layers of the deep neural network component based on at least one of a transformation function, a predefined filter, a weight, and a bias component to generate an output indicative of a category of the input dataset;
based on the processing of the formatted dataset, determining, by the processor, a classification indicative of a probability of a data feature of the input dataset corresponding to an identity parameter associated with an identity of the individual, the identity parameter being indicative of sensitive data; and
providing, by the processor, to a user, the data feature of the input dataset corresponding to the identity parameter in a first format and another data features of the input dataset in a second format different than the first format.

10. The method as claimed in claim 9 wherein selecting the type of the deep neural network component further comprises:
identifying, by the processor, a characteristic associated with the input dataset based on a pre-defined parameter, where the pre-defined parameter comprises at least a size of the input dataset and/or a length of individual elements in the dataset;
selecting, by the processor, the type of the deep neural network component as a convolutional neural network component, when the input dataset is associated to a first characteristic; and
selecting, by the processor, the deep neural network component as a recurrent neural network component when the input dataset is associated to a second characteristic.

11. The method as claimed in claim 10, wherein when the deep neural network component is selected as the convolutional neural network component, determining the classification further comprises:
encoding, by the processor, the input dataset based on quantization of each character of the input dataset using a one-hot encoding component and a first dictionary;
determining, by the processor, a first formatted dataset based on the encoding of the input dataset, wherein the first formatted dataset is in the two-dimensional data structure representing a matrix of binary digits;
processing, by the processor, the first formatted dataset by a first set of layers of the convolutional neural network component using a one-step stride and at least a predefined filter;
based on the processing of the first formatted dataset, computing, by the processor, a first output data indicative of a one-dimensional convolution of the first formatted dataset;
processing, by the processor, the first output data by a second set of layers of the convolutional neural network component, wherein the second set of layers corresponds to fully connected layers of the artificial neural network; and
based on processing, by the processor, the first output data, computing a second output data indicative of the classification of the input dataset.

12. The method as claimed in claim 11, wherein the first dictionary comprises sixty-eight characters, the first set of layers comprises six layers, the second set of layers comprises two layers, and the first formatted dataset is one hundred and fifty bits long.

13. The method as claimed in claim 10, wherein when the deep neural network component is selected as the recurrent neural network component, determining the classification further comprises:
encoding, by the processor, each character of the input dataset using an embedded matrix corresponding to a set of embedding layers of the recurrent neural network component, a second dictionary, a dictionary index corresponding to the second dictionary, and a weight corresponding to each embedding layer of the embedding matrix;
determining, by the processor, a second formatted dataset based on the encoding of the input dataset, wherein the second formatted dataset is of a predefined length;
processing, by the processor, the second formatted dataset by a backward feedback layer component and a forward feedback layer component of a bi-directional long short term component of the recurrent neural network component to generate a third output data;
processing, by the processor, the third output data of the bi-directional long short term component by an adaptive maximum pooling layer function to generate a fourth output data and an adaptive average pooling layer function to generate a fifth output data;
concatenating, by the processor, the fourth output data and the fifth output data using a concatenation layer function to generate a sixth output data; and
processing, by the processor, the sixth output data by a third set of layers corresponding to end-to-end connected layers of the recurrent neural network component to generate a seventh output data indicating the classification of the input dataset.

14. The method as claimed in claim 13, wherein the second dictionary comprises sixty eight characters, the second formatted dataset is ten bits long, and the set of embedding layers comprises twenty four embedding layers.

15. A non-transitory computer readable medium including machine readable instructions that are executable by a processor to:
obtain an input dataset comprising data associated with an individual, wherein the input dataset is defined in a one-dimensional data structure;
select a type of a deep neural network component based on a characteristic of the input dataset;
convert the input dataset into a formatted dataset of a two-dimensional data structure by encoding each character of the input dataset using a predefined dictionary and a predefined encoding function, wherein a format of the formatted dataset is defined in accordance to the type of the deep neural network component;
process the formatted dataset through a plurality of layers of the deep neural network component, the processing comprising transforming the formatted dataset at each layer of the plurality of layers of the deep neural network component based on at least one of a transformation function, a predefined filter, a weight, and a bias component to generate an output indicative of a category of the input dataset;
based on the processing of the formatted dataset, determine a classification indicative of a probability of a data feature of the input dataset corresponding to an identity parameter associated with an identity of the individual, the identity parameter being indicative of sensitive data; and
provide to a user the data feature of the input dataset corresponding to the identity parameter in a first format and another data features of the input dataset in a second format different than the first format.

16. The non-transitory computer-readable medium as claimed in claim 15 including machine readable instructions that are executable by the processor to further:
identify a characteristic associated with the input dataset based on a pre-defined parameter, where the pre-defined parameter comprises at least a size of the input dataset and/or a length of individual elements in the dataset;
select the type of the deep neural network component as a convolutional neural network component, when the input dataset is associated to a first characteristic; and
select the deep neural network component as a recurrent neural network component when the input dataset is associated to a second characteristic.

17. The non-transitory computer-readable medium as claimed in claim 16, including machine readable instructions that are executable by the processor to further:
encode the input dataset based on quantization of each character of the input dataset using a one-hot encoding component and a first dictionary;
determine a first formatted dataset based on the encoding of the input dataset, wherein the first formatted dataset is in the two-dimensional data structure representing a matrix of binary digits;
process the first formatted dataset by a first set of layers of the convolutional neural network component using a one-step stride and at least a predefined filter;
based on the processing of the first formatted dataset compute a first output data indicative of a one-dimensional convolution of the first formatted dataset;
process the first output data by a second set of layers of the convolutional neural network component, wherein the second set of layers corresponds to fully connected layers of the artificial neural network; and
based on processing the first output data, compute a second output data indicative of the classification of the input dataset.

18. The non-transitory computer-readable medium as claimed in claim 17, wherein the first dictionary comprises sixty-eight characters, the first set of layers comprises six layers, the second set of layers comprises two layers, and the first formatted dataset is one hundred and fifty bits long.

19. The non-transitory computer-readable medium as claimed in claim 16, wherein when the deep neural network component, is selected as the recurrent neural network component, determining the classification further comprises:
encode each character of the input dataset using an embedded matrix corresponding to a set of embedding layers of the recurrent neural network component, a second dictionary, a dictionary index corresponding to the second dictionary, and a weight corresponding to each embedding layer of the embedding matrix;
determine a second formatted dataset based on the encoding of the input dataset, wherein the second formatted dataset is of a predefined length;
process the second formatted dataset by a backward feedback layer component and a forward feedback layer component of a bi-directional long short term component of the recurrent neural network component to generate a third output data;
process the third output data of the bi-directional long short term component by an adaptive maximum pooling layer function to generate a fourth output data and an adaptive average pooling layer function to generate a fifth output data;
concatenate the fourth output data and the fifth output data using a concatenation layer function to generate a sixth output data; and
process the sixth output data by a third set of layers corresponding to end-to-end connected layers of the recurrent neural network component to generate a seventh output data indicating the classification of the input dataset.

20. The non-transitory computer-readable medium as claimed in claim 19, wherein the second dictionary comprises sixty eight characters, the second formatted dataset is ten bits long, and the set of embedding layers comprises twenty four embedding layers.
